(19) United States
(12) Patent Application Publication
(10) Pub. No.: US 2004/0189439 A1
(43) Pub. Date: Sep. 30, 2004

(54) Local and remote management of lock systems from a network

(76) Inventor: Juan Miguel Dominguez Cansino, Sevilla (ES)

Correspondence Address: JACOBSON HOLMAN PLLC, 400 Seventh Street, N.W., Washington, DC, 20004-2218, US

(21) Appl. No.: 10/401,033

(22) Filed: Mar. 28, 2003

(51) Int. Cl. H04Q 1/00; G05B 19/00

(52) U.S. Cl. 340/5.2; 340/5.33

(57) ABSTRACT

A local and remote lock management system including at least one electronic control device that allows electronic/electromechanical locks with an electronic keypad to be managed locally and remotely from a network supporting the TCP/IP protocol, thus benefiting from all the advantages provided by the Internet, and a remote lock management program for locally and remotely managing electronic/electromechanical locks through the at least one control device. Each lock is associated with its own control device having its own IP address. A basic, directly-connected configuration of the IP lock management system has an architecture with a series of electronic locks, the control devices for each lock acting as a Web server for any Internet/Intranet client that wants to connect remotely to it. The control devices serve up configuration and/or inquiry Web pages, handles interactions with the local keypad, and respond to remote orders that the remote lock management program gives from any control post on the network. A master/slave configuration has an architecture in which the system has a series of locks, only one of which has a web server. All locks are connected to the network. If a user wants to access the master and slave locks, the user will connect to the master control device, and from that single session the user will access the parameters of all the other control devices.

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The invention relates to the local and remote management of lock systems for containers and the custody of cash and other valuables, and more particularly, to the local and remote management of electronic/electromechanical locks from a network supporting the TCP/IP Protocol.

### BACKGROUND OF THE INVENTION

Electronic/electromechanical locks systems are standard in banks, other commercial enterprises, and government agencies. Typically, the locks in these systems not only have basic locking and unlocking operations, but also have a number of operating parameters that can be manipulated. Some of these operating parameters are described in U.S. Pat. No. 5,774,058 to Henry, and include:

(1) Require-PIN-Entry operating parameter, which enables and disables the requirement that a PIN be entered for each key that attempts to login to the lock

(2) PIN-Life operating parameter, used to specify a number of days in which a PIN may be left unchanged

(3) Idle-Key-Life operating parameter, used to specify an interval within which a login of a particular key must occur before the key will be deactivated by the server

(4) PIN-Reject-Limit operating parameter, which specifies the number of unsuccessful login attempts that will be permitted prior to the application of a pin rejection penalty

(5) PIN-Entry-Timeout operating parameter, which specifies the maximum length of time that may expire between a user's entering of successive PIN digits

(6) Duress-PIN-Mode operating parameter, which allows a user to access the lock using a PIN code modified from the user's real PIN code when being forced to access the lock, so that the server will activate an attached alarm as well as allowing the user access to the lock

(7) Location-Code operating parameter, which uniquely identifies the lock from among other similar locks owned by the same purchaser

(8) Daylight-Savings-Schedule operating parameter, which enables a user to change the dates upon which daylight savings time changes are made effective

(9) Door-Configuration operating parameter for each door, which includes the door type, the solenoid and sensor associated with the door (if any), and which other door that the current door is “behind”

(10) Openable-Interval operating parameters, which define up to five time intervals in which a door can be opened

(11) Timelock-Early operating parameter, which allows a user to timelock an outer door during an openable interval if the Timelock-Early parameter is enabled

(12) Timelock-Override operating parameter, which enables a pair of users to unlock the lock at a time that is not within an openable interval

(13) Delay-Interval, Access-Interval, and Open-Warning-Interval operating parameters for each door, which identify the access sequence for that door

Typically, the locking and unlocking operations can be performed and operating parameters can be manipulated locally. However, especially for those organization, such as banks, that have multiple locations, each of which with multiple locks, there are many situations when it would also be desirable to manipulate and configure a lock remotely especially those organizations that have multiple locations, each of which with multiple locks.

Integrated systems are defined by an architecture based on the devices to be controlled, the data acquisition, and control system or management hardware that actually controls and manages the system and the communications medium or information transportation. This management program is usually installed on PC platforms with Windows®-like, off-the-shelf operating systems, and offers control center operators a graphic interface to manage and process events. This classical architecture has a series of problems that are fundamentally derived from the dependence of the equipment to be controlled on the management PC's.

There are different types of communications channels or media between the management center and the devices: industrial buses that comprise a proprietary network, analog or digital telephone lines, computer data networks, etc. Regardless of the communications medium, the dependence on the PC and its related software is a determining factor for centralization.

The Evora lock marketed by Fichet-Bauche, the Peg@sus system marketed by Tecnosicurezza, the Cesar system marketed by Ferrimax S. A., and the spider lock of Baussa all provide remote control of electronic/electromechanical locks via a computer network. However, all of these systems require a Local Area Network (“LAN”) and a computer at the site where the locks are located, which computer has special, resident software and communicates with the lock or locks through the LAN. For security and economic reasons, banks and other commercial institutions do not want to use a remote-control system that requires special, resident software on one or more computers in their network, and that requires of the LAN. In traditional systems, the locks cannot be directly connected to the network.

It is to the solution of these and other objects to which the present invention is directed.

### BRIEF SUMMARY OF THE INVENTION

It is therefore a primary object of the present invention to provide a local and remote system that allows electronic/electromechanical locks to be accessed and managed either locally by keypad or remotely by network from a network supporting the TCP/IP protocol without the need for proprietary software.

It is another object of the present invention to provide a local and remote system employing electronic/electromechanical locks that places at the user's disposal all information available on locks within the system and allows remote real-time control of each lock.

It is still another object of the present invention to provide fully integrated physical security for containers.

It is still another object of the present invention to provide a local and remote system that allows electronic/electromechanical locks to be managed through direct connection of the to a network.

The above and other objects of the invention are achieved by provision of a local and remote lock management system comprising at least one electronic control device that allows electronic/electromechanical locks with an electronic input device such as a keypad to be managed locally and remotely from a network supporting the TCP/IP protocol, thus benefiting from all the advantages provided by the Internet, and a computer-resident lock management program for remotely managing electronic/electromechanical locks from a central control center through the at least one control device. Each lock is associated with its own control device, which has its own Internet Protocol (“IP”) address.

The Internet explosion in our society marks the “before” and “after” starting line in the management and exchange of resources and information at all levels. The Internet is, in essence, the union of an infinite number of computers throughout the world, in order to share resources and information. The “engines” of this union are the servers, and all the personal computers connected to those servers are clients. The Internet also has a user-friendly, standard system to publish and collect information on the network, the World Wide Web (or simply “the Web”). The Web is accessed through a Web browser, which is the program that allows users to connect to and view the web sites they visit.

A directly connected configuration of the IP lock management system in accordance with the present invention has electronic/electromechanical locks that have their own control devices. Each of the control devices has its own IP address assigned, so that it acts as a Web server for any Internet/Intranet client. The lock can be programmed by using a keypad, web browser, or by using a remote lock management program in accordance with the present invention.

In an alternative embodiment, the IP lock management system can have a master/slave configuration by using one control device as the interface for a group of locks. In the master/slave configuration, the system has a series of locks, each one with an associated control device having its own IP address, but which at the Web browsing level can only be connected to one lock through an associated control device that also has a built-in Web browser. This configuration centralizes access to the rest of the locks, and unifies the interface into a single lock. If a user wants to access the locks at a facility, the user communicates with a single control device, and from that single session the user will access the parameters of all the other control devices.

In electronic/electromechanical locks with an electronic keypad, the combination (also referred to as the “access code”) for the lock is a series of discrete voltages or digital signals, which are generated by the keys of the keypad. The control device in accordance with the present invention includes a microprocessor having its own IP address and Web Server allowing an electronic/electromechanical locks to be managed either remotely or locally from a network supporting the TCP/IP protocol, without the need for a proprietary program. The Web Server is part of a control device program that provides the control device with peripheral control, as well as control and supervision of the temporary processes that govern the lock (blocks, delay time, etc.). The microprocessor also has a program for converting digital signals produced by a computer into analog signals (that is, discreet voltages) for controlling the lock in place of the analog keypad.

The control device is in communication with the lock, and can be integrated into the electronic keypad housing, or it can be separate from the electronic keypad housing. Also, the control device can be outside or inside the container, with the keypad outside the container.

The control device also is connected to a LAN/WAN. Because the control device has its own IP address, the lock connected to the control device is recognized by the LAN/WAN. The lock can therefore be accessed by any computer on the LAN/WAN.

Interaction with the control device takes place through a standard, off-the-shelf Web browser (for example, Internet Explorer™, Netscape™, etc.) and its communications medium is any network supporting the TCP/IP Protocol, which includes local and/or corporate networks (Internet/Intranets) and public networks (the Internet). This Web technology-based design gives the control device all the standardization and compatibility of the Internet itself, so that the control device is independent of the platform on which it is installed and the operating system being used.

As part of the LAN, the control device is behind, and protected by, the network firewall. Therefore, if there is a Network (“LAN/WAN”) connecting to the LAN, the lock can be accessed over the LAN/WAN and will be protected by the network firewall. For organizations such as banks with a number of locations, each having a LAN connecting to a LAN/WAN, the remote lock management program in accordance with the present invention makes it possible for a person at one location, for example the bank central office, to program a lock at another location, for example a bank branch office, could remotely access their locks through a WAN.

Some of the lock programming features that can be controlled locally from the keypad and remotely through the network are:

(1) Users: who can use/operate the lock

(2) Time locks: lock enable/disable (when a lock can be opened)

(3) Time delay: length of time between entry of the lock combination and opening of the lock (used for robbery protection)

(4) Audit trail: who has opened the lock, what time the lock was opened and closed, etc.

The remote lock management system in accordance with the present invention can also be used to check from a remote location the condition of various lock switches, for example, lock condition (locked/unlocked), bolt position (extended/retracted), and safe door position (open/closed).

Other objects, features and advantages of the present invention will be apparent to those skilled in the art upon a reading of this specification including the accompanying drawings.

### BRIEF DESCRIPTION OF THE DRAWINGS

The invention is better understood by reading the following Detailed Description of the Preferred Embodiments with reference to the accompanying drawing figures, in which like reference numerals refer to like elements throughout, and in which:

FIG. 1A is a diagrammatic representation of a basic, directly-connected configuration of a remote lock management system in accordance with the present invention.

FIG. 1B is a, diagrammatic representation of a master/slave configuration of a remote lock management system in accordance with the present invention.

FIG. 2A is a diagrammatic representation of the general organization of the CPU module of the control device of the IP lock management system.

FIG. 2B is a diagrammatic representation of an embodiment of the control device microprocessor.

FIG. 3A is a perspective view of a control device configured as circuitry only for remote use.

FIG. 3B is a perspective view of a control device integrated into a housing with a keypad and a display.

FIGS. 4A-4C are diagrammatic representations of the actions that can be taken using the keyboard of the control device.

FIG. 5 is a flow diagram of the control device firmware.

FIG. 6 is a diagrammatic representation of the organization of locks and their associated control devices in a basic, directly-connected configuration of the IP lock management system.

FIGS. 7A-7NN are illustrations of exemplary screens or portions of screens by which the remote lock management program interacts with the user in centralized remote control mode.

FIGS. 8A-8BB are illustrations of exemplary screens or portions of screens by which the remote lock management program interacts with the user in remote mode.

### DETAILED DESCRIPTION OF THE INVENTION

In describing preferred embodiments of the present invention illustrated in the drawings, specific terminology is employed for the sake of clarity. However, the invention is not intended to be limited to the specific terminology so selected, and it is to be understood that each specific element includes all technical equivalents that operate in a similar manner to accomplish a similar purpose.

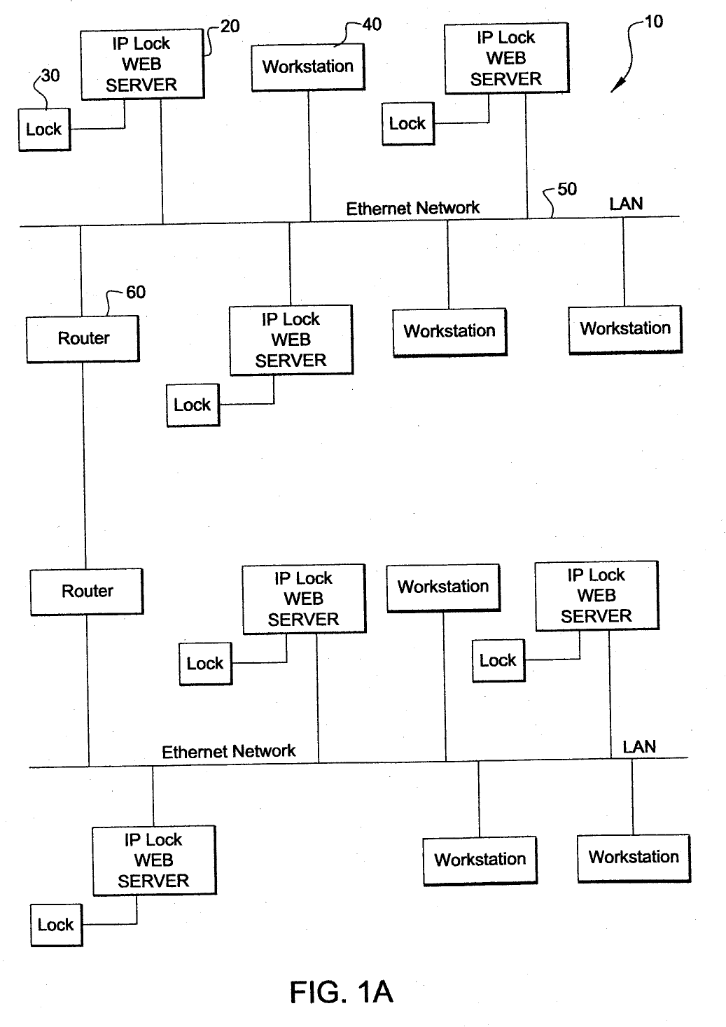

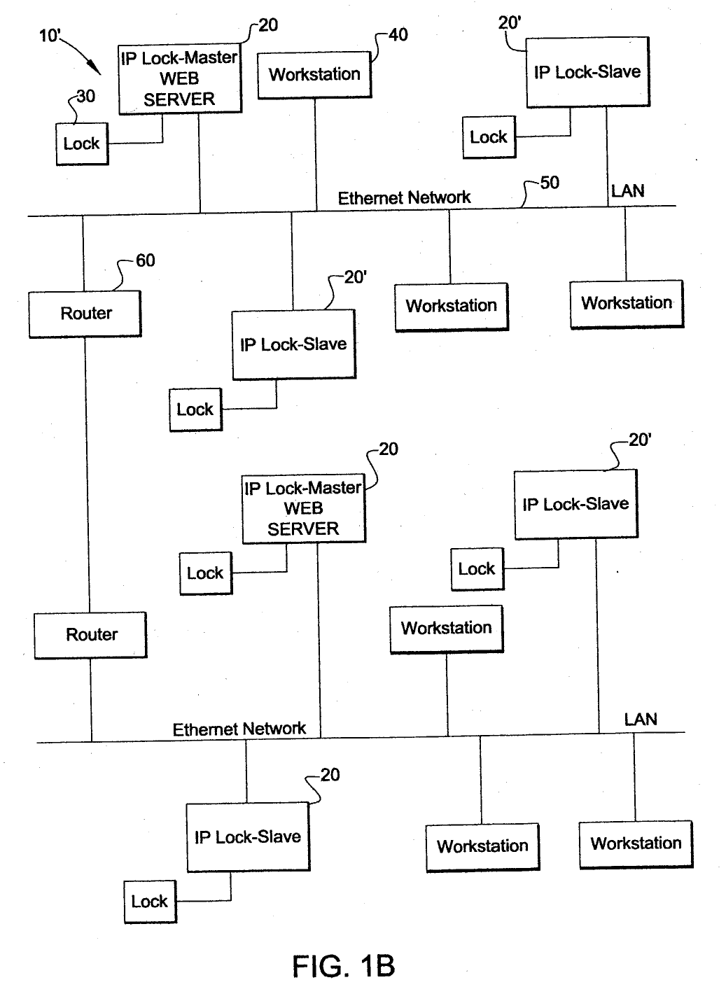

Referring to FIGS. 1A and 1B, an IP lock management system 10 or 10′ in accordance with the present invention comprises at least one electronic control device 20 that allows electronic/electromechanical locks 30 with an electronic keypad (not shown) to be managed locally (through the control device) and remotely (for example, through a computer workstation 40) from a network 50 supporting the TCP/IP protocol, thus benefiting from all the advantages provided by the Internet, and a computer-resident remote lock management program for locally and remotely managing electronic/electromechanical locks through the at least one control device. The remote lock management program is not required to access and administer the locks. It is only needed for accessing and administering multiple locks simultaneously.

The basic, directly-connected configuration of the IP lock management system 10 in accordance with the present invention has the architecture shown in FIG. 1A. This configuration comprises a series of electronic/electromechanical locks 30 that are in turn connected to the control devices 20. Each of the control devices has its own IP address assigned, so that it acts as a Web server for any Internet/Intranet client that wants to connect remotely to it.

In an alternative embodiment, shown in FIG. 1B, the IP lock management system 10′ can have a master/slave configuration. In the master/slave configuration, only one of the control devices 20 has a built-in Web Server to control selected locks in the LAN. That is, the system has a series of locks 30, each one with an associated control device 20′ having its own IP address, but which at the Web browsing level can only be connected to one lock through an associated control device 20 that also has a built-in Web server. This master/slave configuration centralizes access to the rest of the locks, and unifies the interface into a single lock. If a user wants to access the locks at a facility, the user will connect to a single control device, and from that single session the user will access the parameters of all the other control devices.

The master/slave configuration allows a user to control all the control devices of a facility through a single Web server, that is to say, the end user will see the full lock management system on a single Web page without being concerned about updating the data, because the Master control device will take charge of it.

The control device includes a printed circuit board (not shown) with a CPU module 20a, a feed module (not shown), a capture, translation, and transmission module (not shown), and a user interface module (not shown) (herein collectively referred to as “the circuitry”).

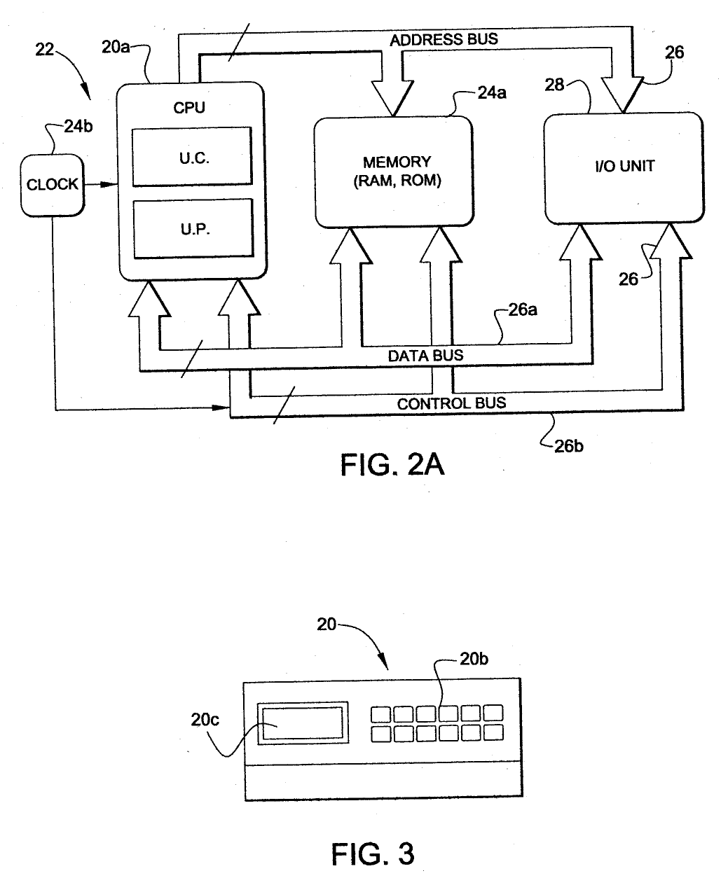

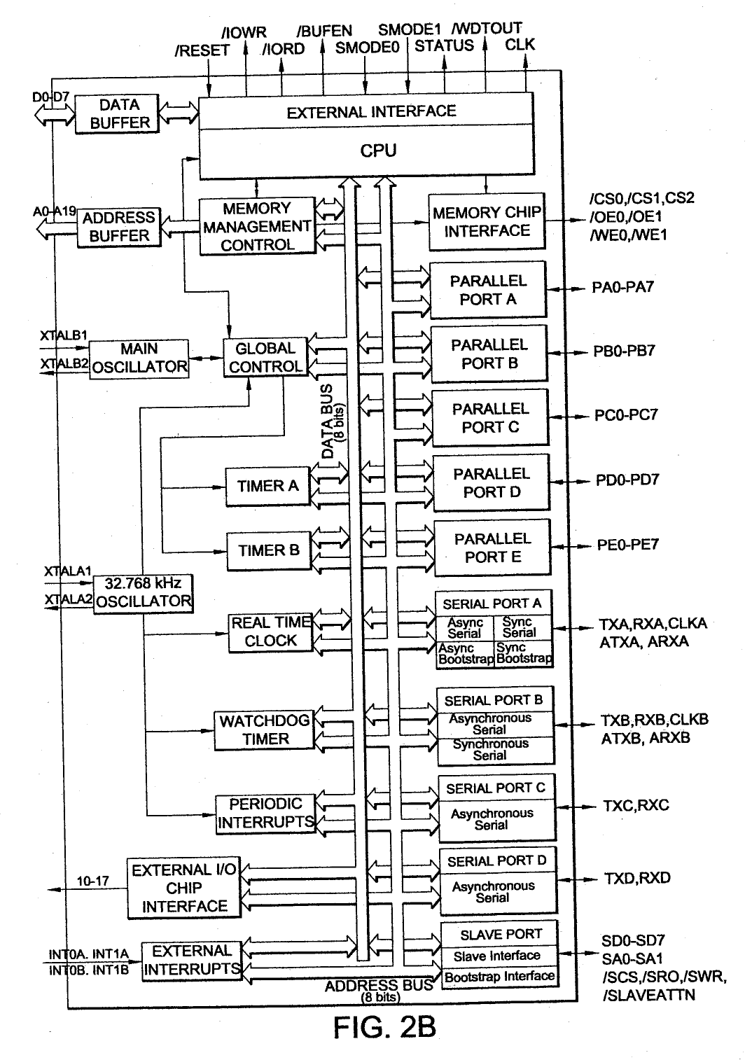

The general organization of the CPU module 20a is shown in FIGS. 2A and 2B. The CPU module includes a CPU 22 and three submodules, a memory submodule 24a, a restart submodule (FIG. 2B), and a clock submodule 24b, as well as a bus system 26 connecting the CPU to the outside or to an I/O unit 28. The CPU preferably is a microprocessor. For instance, in one embodiment, the CPU is a Z180 family microprocessor, specifically the Rabbit R-2000 microprocessor, shown in FIG. 2B. The microprocessor has two internal timing registers, four general-purpose parallel ports, four serial ports (alternate function of parallel port C), as well as four external interrupt sources. It also includes a master/slave port for master/slave configurations, external input/outputs to control access to devices such as memory, A/D and D/A converters, and a control unit for a total of 1 megabyte of addressable memory (because the internal address bus of the micro is 16 bits (64 kilobytes).

The function of the memory submodule is to hold all the instructions that are dumped into the microprocessor once power is provided to the circuitry, so that the microprocessor can execute them, which will result in a software- or hardware-level event. The memory submodule comprises a circuit having external storage memory (for example, flash and EEPROM) and dynamic storage memory (RAM). In one embodiment, the memory submodule comprises four memory banks: two 256K flash memory banks, one 512K SE serial RAM, and one I²C bus EEPROM. Over time, these devices allow programs to be stored on the order of megabytes, but the limit will be imposed by the microprocessor, because the total memory (EEPROM plus RAM), which may be address-related or control a microprocessor, will depend on the width of the address bus it has.

The system control bus 26b carries the control pulses that the microprocessor 20a sends to the entire system to choose who is being addressed at each time. The data bus 26a carries the binary data that is being written to or read from any storage device.

The restart submodule comprises an internal watchdog (for example, a Micrel 811 WatchDog-based reset circuit), which detects when the system becomes frozen or “stuck” in a non-operating state due to hardware failure or program malfunctions, and issues a system-reset signal. The clock submodule comprises an internal real-time clock that provides a clock signal for each system element.

The feed module supplies power to the circuitry from outside with a continuous stabilized voltage of 9 volts dc. Internally, the circuitry has a 7805-type regulator for converting to the circuitry's native 5 volts dc. voltage.

The capture, translation, and transmission module includes three submodules: a digital I/O submodule, a serial submodule, and a TCP/IP submodule. In the digital I/O submodule, the inputs and outputs are open collectors. The serial submodule is configured as a standard RS-232 port. For example, the TCP/IP submodule can comprise an Ethernet RTL8019A-based microprocessor and a logical part comprising a TCP stack.

The user interface module comprises a user-side 12-digit keypad 20b input via a negative voltage circuit, a matrix character display output or a touch panel graphic display output 20c.

In electronic/electromechanical locks with an electronic keypad, the combination for the lock is a series of discrete voltages or a digital signal, which are generated by the keys of the keypad. The microprocessor has a program for converting digital signals produced by a computer into analog signals for controlling an analog lock in place of the keypad.

In the control device in accordance with the present invention, the microprocessor has its own IP address and Web program, so that it acts as its own Web server, allowing an electronic/electromechanical lock to be managed either remotely through a network supporting the TCP/IP Protocol or locally from a keypad, without the need for proprietary programming. The Web Server is part of the control device. Through the network, the peripheral devices may be controlled, as well as operating parameters for the lock.

The control device is in communication with the lock, and can be configured physically in multiple forms, for example, as the circuitry only when it is used remotely; the circuitry integrated into a housing with an input device (such as a keyboard or touch screen) and a display (FIG. 3); or the circuitry integrated into an off-the-shelf keyboard (not shown). Also, the control device can be outside or inside the safe, with the keypad outside the safe.

The circuitry is connected to a LAN/WAN. Because the microprocessor has its own IP address, the lock connected to the circuitry is recognized by the LAN/WAN. The lock can therefore be accessed through any computer on the LAN/WAN.

A user interacts with the control device through a standard, off-the-shelf Web browser (for example, Internet Explorer®, Netscape®, etc.) and its communications medium is any TCP/IP protocol network (Intranet/Internet). This Web technology-based design gives the control device all the standardization and compatibility of the Internet itself, so that the control device is independent of the platform on which it is installed and the operating system being used for remote access.

As part of the LAN, the control device is behind, and protected by, the network firewall. Therefore, if there is a LAN/WAN connecting to the LAN, the lock can be accessed over the LAN/WAN and will be protected by the network firewall. For organizations such as banks with a number of locations, each having a LAN connecting to a LAN/WAN, the remote lock management system in accordance with the present invention makes it possible for a person at one location, for example the bank central office, to program a lock at another location, for example a bank branch office.

Some of the lock programming features that can be controlled locally from the keypad and remotely through the network are:

(1) Users: who can use/operate the lock

(2) Time locks: lock enable/disable (when a lock can be opened)

(3) Time delay: length of time between entry of the lock combination and opening of the lock (used for robbery protection)

(4) Audit trail: who has opened the lock, what time the lock was opened and closed.

A remote lock management program can also be used to check from a remote location the condition of various lock switches, for example, lock condition (locked/unlocked), bolt position (extended/retracted), and safe door position (open/closed). The remote lock management program is not required to access and administer the locks. It is only needed for accessing and administering multiple locks simultaneously.

The control device has five routes or interfaces: (1) a data input/output port to the lock that can be configured depending on the channel that the lock uses to communicate (RS-232 Serial, I/O, etc.); (2) 30 digital general purpose I/O's that can be converted through programming into RS-232 or -485 ports, and/or be used to control external sensors; (3) Ethernet communications; (4) a keypad or touch screen interface; and (5) a graphic display interface.

The signals coming from the keypad are interpreted by the microprocessor of the lock, and the microprocessor of the control device. They are shown on the display and transmitted to the lock to perform the selected operation. The available operations are: (1) ordering the lock to open; and (2) ordering entry into programming mode. The programmable parameters are described hereinafter. All operations are recorded in an events memory located on an onboard integrated circuit.

When the lock access process is triggered from a computer network, the microprocessor, which is in charge of IP communications, delivers the requested data to the Web server, and it shows the information to the Web client in Web page format (for example, HTML, JavaScript®). The operations that can be performed are also described hereinafter.

The communications channel of the control device corresponds to Ethernet standard IEEE 802.3 for 10M networks (IEEE 802.3 is the IEEE standard defining the hardware layer and transport layer of (a variant of) Ethernet, according to which the maximum segment length is 500 m, the maximum total length is 2.5 km, the maximum number of hosts is 1024, and the maximum packet size is 1518 bytes). The channel is bi-directional and establishes communications between a Web client, and the embedded server resident in the main microprocessor. Other types of communications, such as Global System for Mobile Communications (“GSM”), General Packet Radio Service (“GPRS”), wireless, Bluetooth™ (a specification for short-range radio links between mobile computers, mobile phones, digital cameras, and other portable devices), etc., can be implemented by using the free I/O routes.

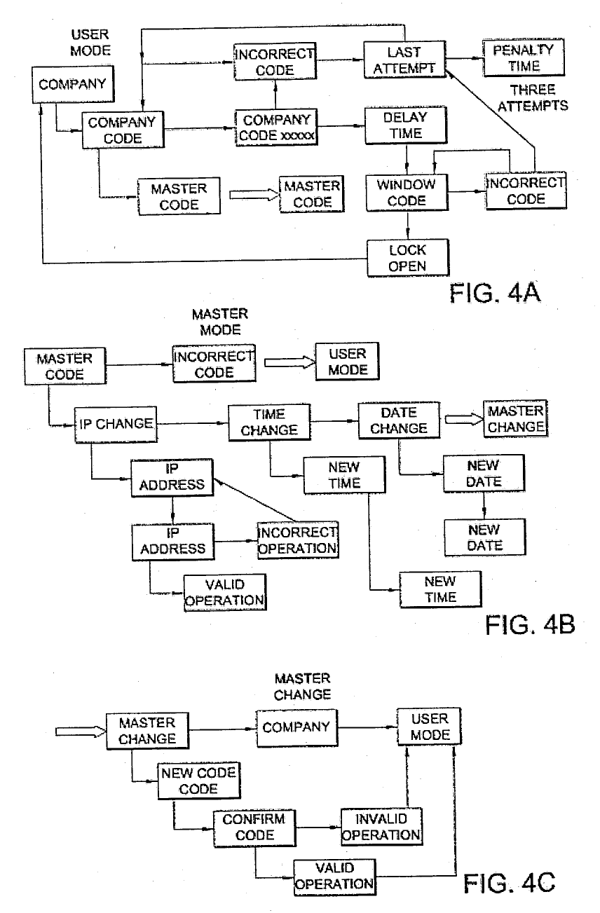

The control device can be used in three different modes, local mode, remote mode, and centralized remote control mode. In local mode, the user accesses the control device from the keypad, where the user can perform operations that allow him or her to activate a lock, change its combination, configure the control device's IP address, and set the date and time, as shown in FIGS. 4A-4C.

The control device is an embedded Web server with all the attributes of any PC-based Web server. A series of TCP/IP stack protocols are implemented in the control device, as follows:

(1) TCP, UDP, IP, ICMP, for the network and transport layers.

(2) HTTP, SMTP and TFTP/SSL, FTP, TELNET for management.

A user who wants to access the control device remotely does not need any proprietary software. In remote mode, the user only has to launch an off-the-shelf Web browser such as Internet Explorer® or Netscape® and place the IP address of the control device in the URL address bar for the lock he or she wants to manage. Once the control device is located, the user will be shown (through his or her Web browser) a series of Web pages that will allow the user to manipulate, control, and configure the control device, as described in greater detail hereinafter. By using standard Internet technology, access to the control device can be achieved from a private network (Intranet) or from a public network (Internet), and thus access to each control device can be fully independent of its geographic location, so that any authorized user can manage any lock in any part of the world online.

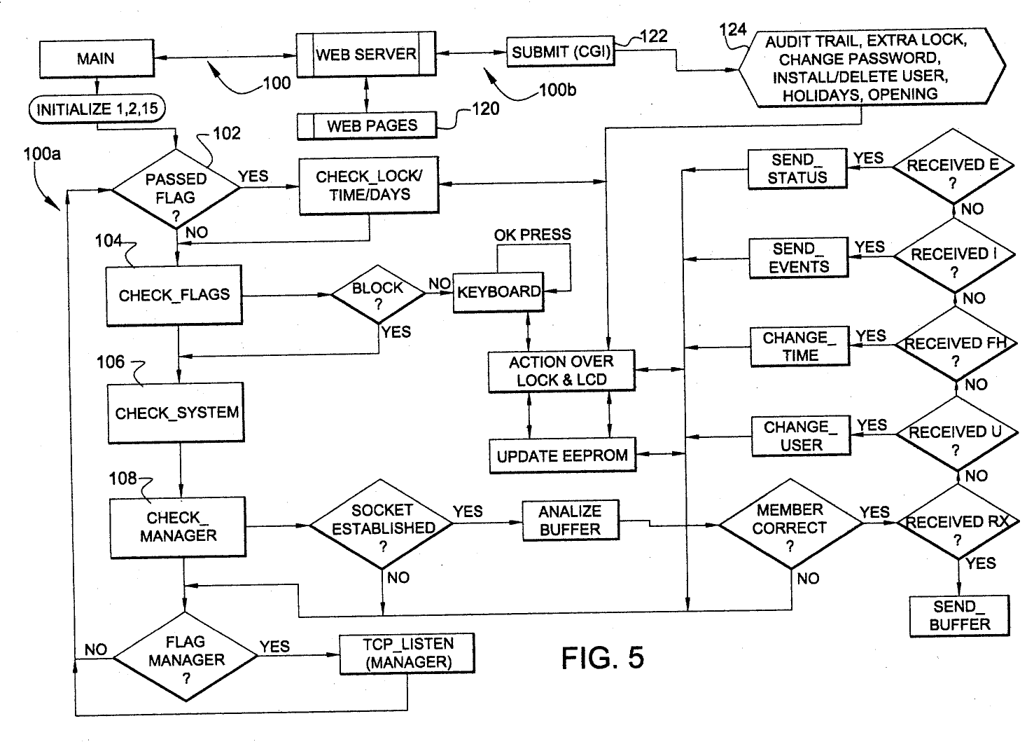

FIG. 5 is a high level flow diagram 100 of the real time program that controls the control devices (the control device program). The control device program comprises a main execution line 100a and a Web server execution line 100b. The main execution line is in charge of providing the control device with peripheral control, as well as control and supervision of the temporary processes that govern the lock (blocks, delay time, etc.). When the circuitry is switched on, it boots, initializing variables that are going to be used in the RAM, as well as reading all the parameters required to control the system (IP, Subnet Mask, Gateway, users, etc.). Peripheral devices such as an LCD or keypad are also booted so that they will operate correctly. The Web server execution line has two routines, one routine 120 being dedicated to serving Web pages and the other routine 122 being a Common Gateway Interface (CGI) routine that processes data received from forms included on those Web pages.

The first step that is executed by the main execution line is the time control step 102. In the time control step, a check is made every 5 seconds to see whether the current time coincides with any block scheduling (weekly, holiday, or special), and if so, action will be taken as a result, blocking the entry of data (password, configuration) whether they come from the keypad or the network. If not, the control device control program continues along the main execution line.

In a second step 104, the main execution line manages a series of flags or indicators, which define the system status, which status will subsequently be analyzed, prior to processing data entry.

In a third step 106, the main execution line continues analyzing a series of parameters that ensure the consistency of system data, as well as the correct functioning of certain aspects of the physical control device circuitry.

In a fourth and last step 108, the main execution line checks whether any data packet has arrived from the remote lock management program. If so, the packet is analyzed and depending on the type of packet action is taken as a result.

All of the dynamic events are stored in memory to define an audit trail. This memory may be encrypted if the application requires.

The Web server execution line works in parallel with the main execution line, the main execution line serving as a master execution line and controlling the flow of data from the network to the main execution line of the control device control program.

Through the Web server execution line, the control device serves up the Web page ordered by a remote client computer and executes the CGI routine 122 that processes the data that arrive from that Web page. These data are processed and stored in the memory for subsequent flag analysis, which is performed later by the main execution line.

The CGI routine is responsible for returning a Web page that reflects the system's response to an event that requires action on the Web page requested. This CGI routine processes the audit trail, special block, password change, adding/deleting users on the lock, capturing holidays and starting the delay time for a given lock, among other features to be added or configured by the end user (indicated by numeral 124).

The remote lock management program is responsible for sending the main configuration (weekly blocks, initial users, holidays) to the control device in a predetermined facility. This is done from a Control Center through the remote lock management program without the need for the installer to know the customer-required configuration of the lock.

The two execution lines are designed for cooperative multitasking, so that a specific routine does not block the action of another except if expressly programmed that way. For the preferred Z180 family microprocessor, this mode of execution has its advantages over preemptive multitasking. The control device is designed without a real time embedded operating system to have complete control of internal processes and external events, thus eliminating the hiding or masking processes., which results in the transparency of execution necessary in a high-security application. Likewise, the latency of the real time system depends on the priority assigned by that system to the processes, which is not always predictable or advisable for applications such as those that concern us.

The control device can be managed in centralized remote control mode using the remote lock management program. The remote lock management program is a resident application installable on a compatible PC. In the embodiment described herein, its minimum operating requirements are: WINDOWS NT/2000/XP (operation under WINDOWS 95/98/ME is not guaranteed); 2X CDROM (for installation); NETWORK CARD with TCP/IP installed; 128 MB RAM; 15 MB hard drive; 800×600 Resolution (no other resolution is allowed).

The remote lock management program is in charge of managing from a PC all locks associated with control devices in accordance with the present invention (hereafter, “control device locks”), which are accessible via the INTERNET using the TCP/IP protocol. Therefore, any desktop or portable PC connected to a network using TCP/IP would be appropriate for housing the application. The remote lock management program must be used in conjunction with one or more control devices, because the remote lock management program interacts with the programs resident in the control devices to access total control over the locks.

The PC preferably is located in an Intranet Internet/Intranet control center and is run on one PC only so as to effectively centralize management, because the changes made to the locks (programming, additions, deletions, etc.) will only be reflected in LOCAL audit trail files, that is, on the specific machine where the program is executed.

The purpose of the remote lock management program is to allow a user to remotely manage control device locks, that is, to individually add, delete and change/program locks, program, and verify their status in a group (including in real time), as well as to access the current configuration of any of them for any inquiries. The actions that the lock management program will allow a user to perform are:

ADD A LOCK. For this action, the user will be asked certain configuration information pertaining to each control device lock. There is no limit imposed by the lock management program on the number of locks that can be added for each LAN, this being defined by the number of hosts (Machines) supported by the network router 60.

DELETE A LOCK. By merely browsing among all the locks on a specific LAN, a user can select the one that the user is going to erase from the lock management program. Deleting a lock only implies that its entry in the local audit trail file disappears, that is to say, the physical configuration of the resource (lock) is not erased.

EDIT A LOCK. Many of the configuration fields are modifiable a posteriori if the user has entered incorrect information when adding, or if the user merely wants to change them. These changes are also local, and for them to be contained in the lock, a programming event must again be launched from the lock management program.

PROGRAM LOCK(S). The lock management program allows a user to program controllable resources individually or collectively. A user-friendly interface provides the second option to the user, so that a set of locks classified by region or another criterion (that is, province, state, etc.). The facility can be configured by applying common templates (as described in greater detail hereinafter).

TEST STATUS. The Status option is a useful tool when diagnosing possible communications faults (and on the network). With this option the lock management program tests (pings) the status of the locks as well as the LAN's router. An intuitive, user-friendly interface allows the user to check as many locks as the user wants. The user can also view the real-time status of a number of locks on a single screen.

EDIT TEMPLATE. A template is very useful because it helps avoid the tedious process of adding one-by-one configuration fields that are identical for geographic reasons, etc. The idea is very simple: it is possible for certain fields, such as holidays or blocks, to be common, for example, to locks in the same city. By applying a template to the add process, the data on the lock configurations are filled in automatically, having then only to fill out fields that are characteristic of each remote element (lock).

All of the above options require a password (the MASTER password) when a user wants to interact with the remote resources from the lock management program. The MASTER password can be changed from the lock management program itself. Bi-directional communication is, therefore, validated by that password.

All users' actions on locks are reflected in a type of LOCAL audit trail in the working file. This audit trail is an ASCII file that serves as a database where all the associated configurations are saved. This configuration has been chosen instead of a local ODBC database to improve the portability of the programming, because the space occupied by 1,000 locks in the ASCII file is only 1 MB. As a precautionary measure, the system records a backup file every two minutes with the full information at that time, so that in case of corruption or loss, the working file can be replaced with its backup file simply by renaming it.

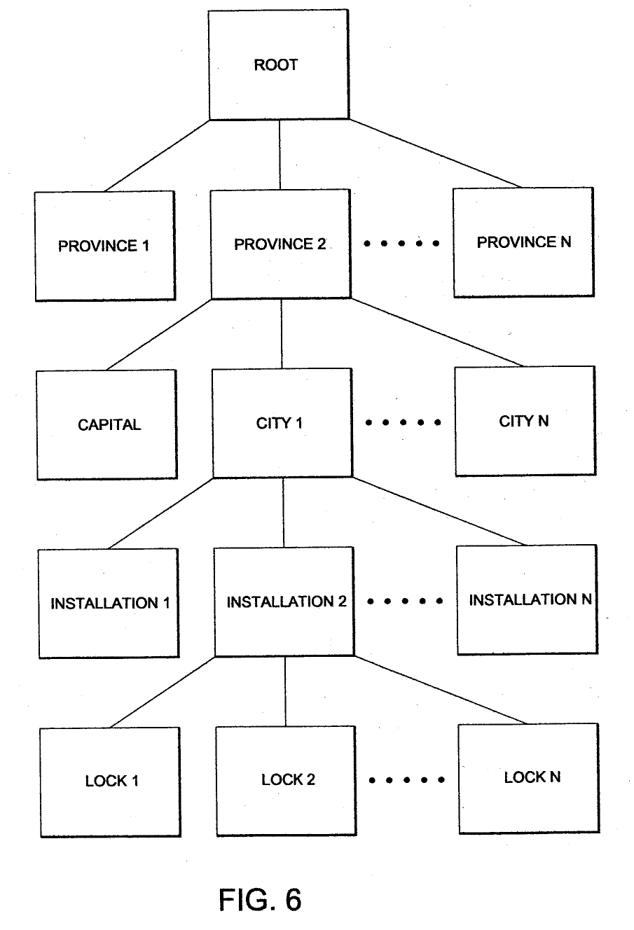

The organization of the locks is arranged hierarchically in tree form, so that the relationship that exists among them and, therefore, part of the information on each, is determined by that structure. This global interrelationship is shown in FIG. 6. This is the structure that the lock management program uses to organize its data internally, because when the lock management program is initialized, the entire hierarchy of the locks is moved to memory from the aforementioned audit trail file.

The template files (characterized by a template extension), the *.log files, and the audit trail must be in the current directory where the lock management program is installed.

The lock management program is divided into several distinct screens interacting with the user. The appearance of each of them is more or less common, retaining the same visual appearance for the location of data input/output menus and zone.

When the program starts, the user is asked for a password. The user can enter the program in two different modes, the Administrator mode and the Operator mode. In the Administrator mode, the user has access to the Administrator option from the main screen. The Administrator has the power to add and delete the 10 operators allowed, as well as to change their passwords. In the Operator mode, the user has access to all options, but lacks the ability to manage other operators (disabled Administrator option), although the user can change his or her personal password.

Every time a user enters and/or exits the lock management program, a file located in the current directory is updated with the date and time of that event, to facilitate control of inputs and outputs to it. It is noted that the lock management program's passwords have NOTHING to do with the Master password, which is the one that allows the user to program the locks. The personal passwords can be changed from the main page (as discussed in greater detail hereinafter).

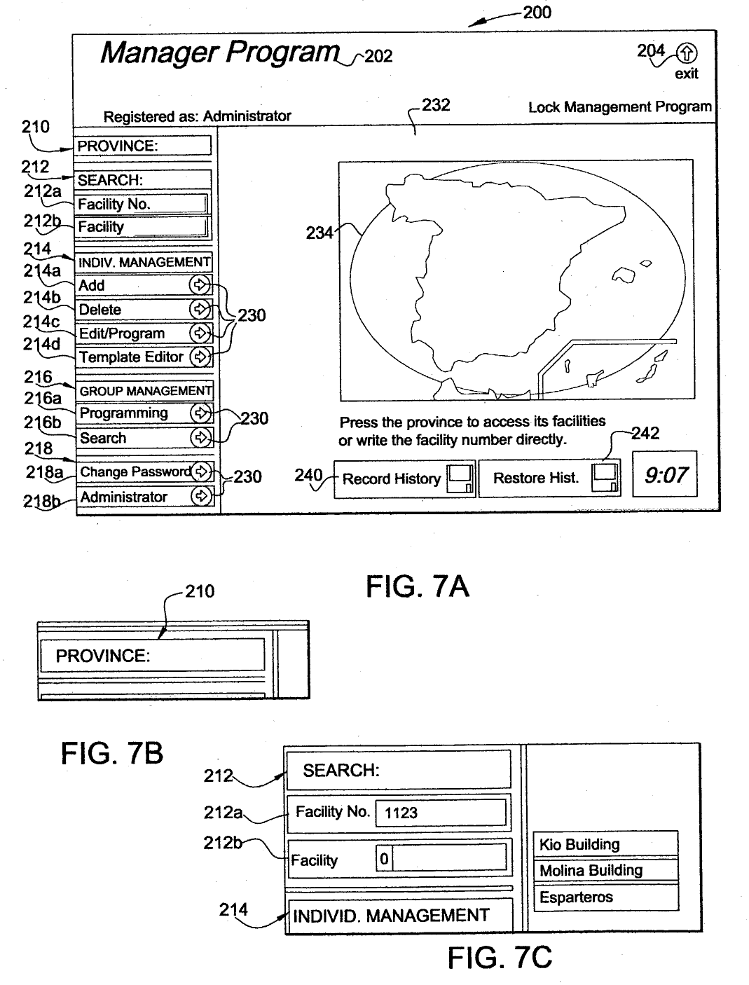

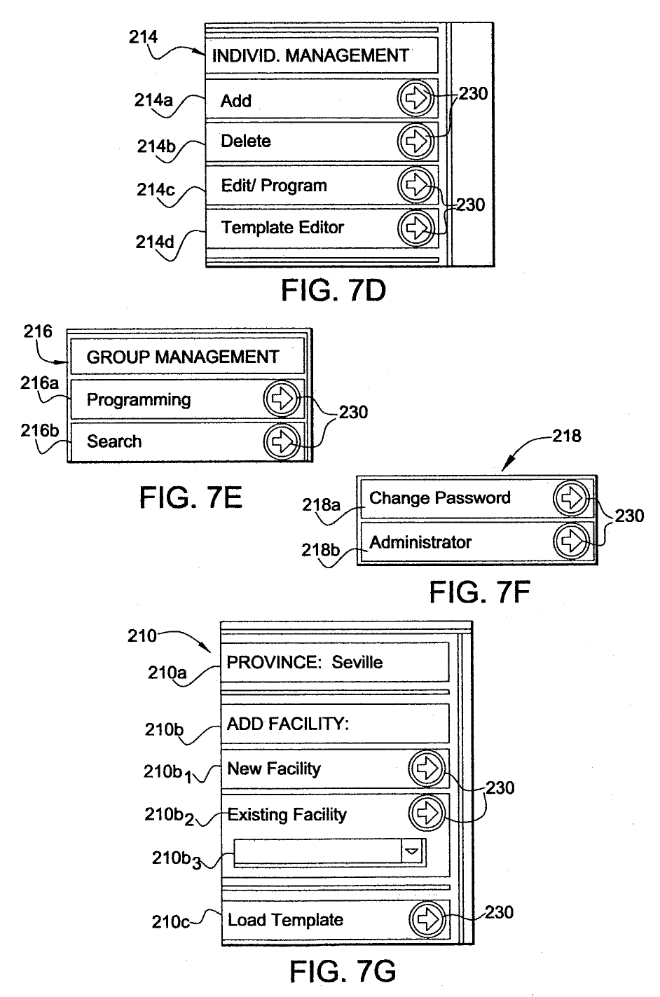

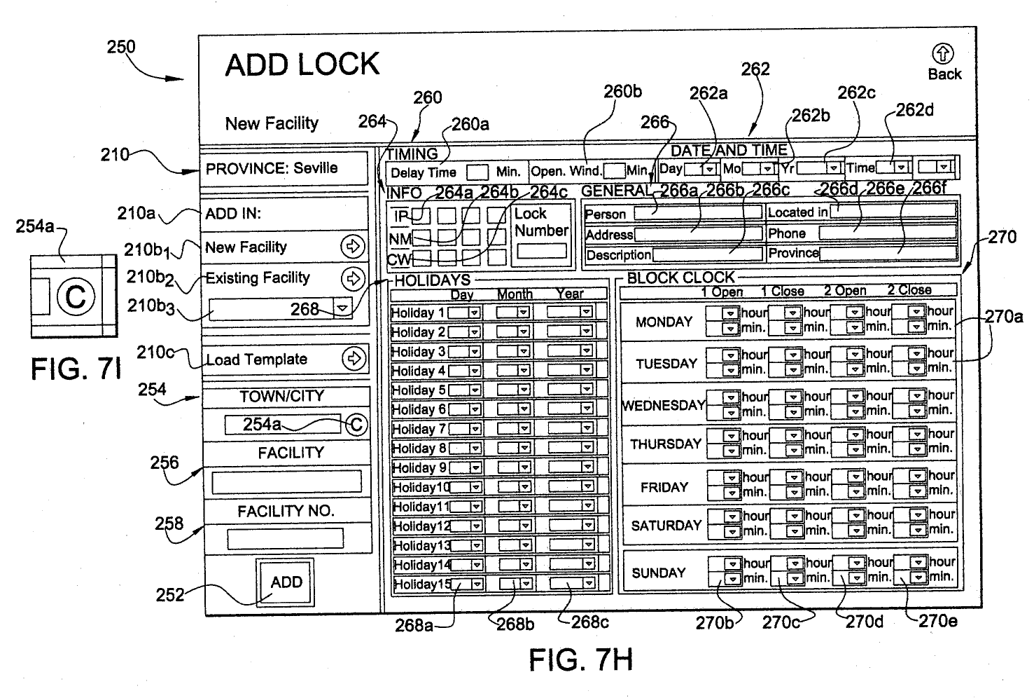

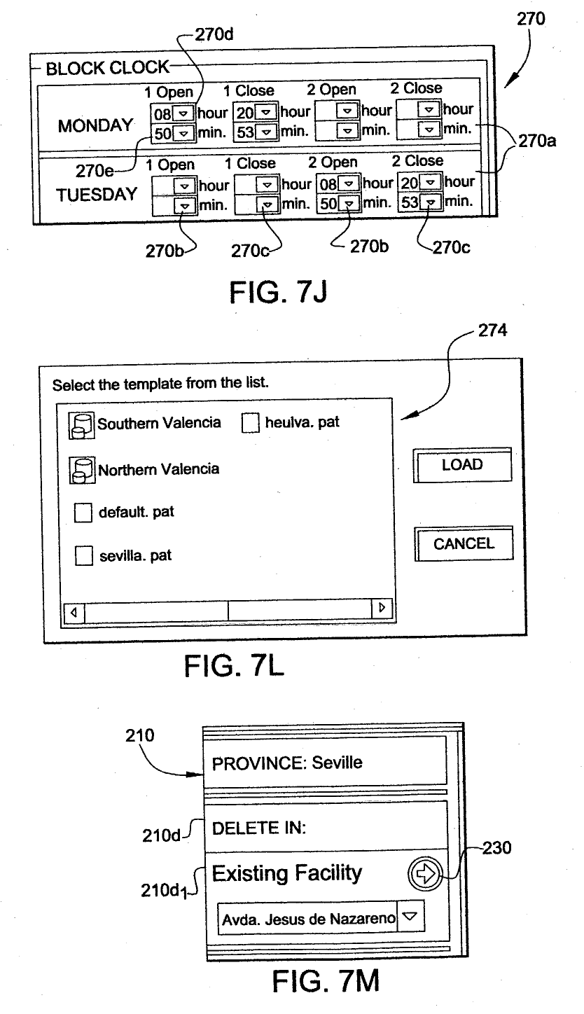

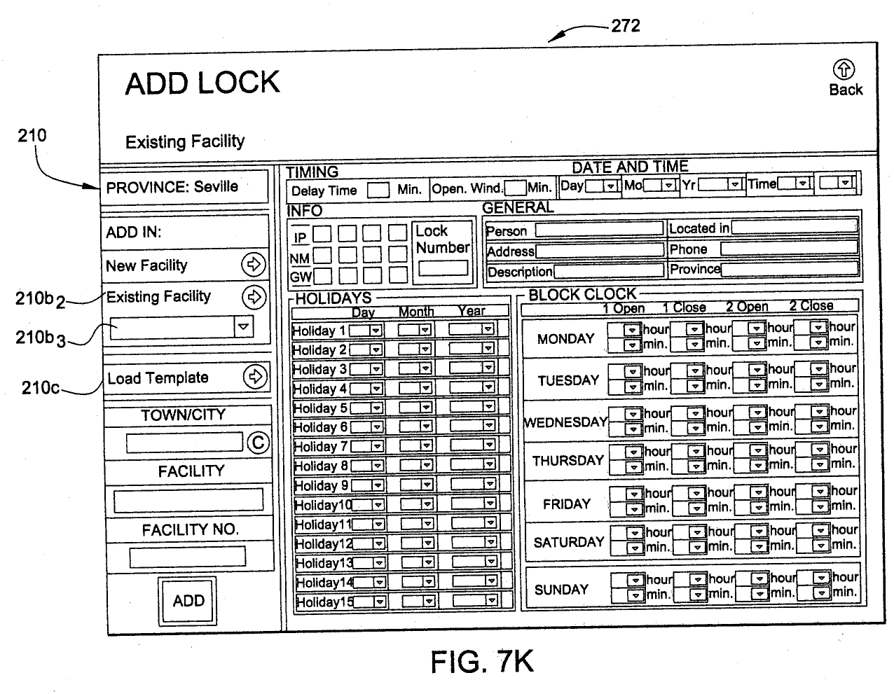

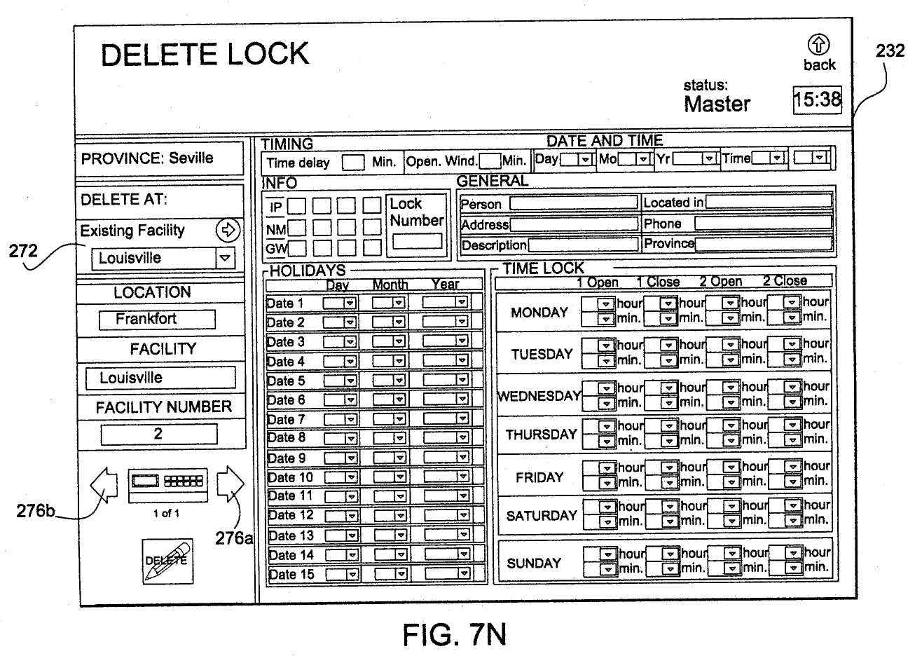

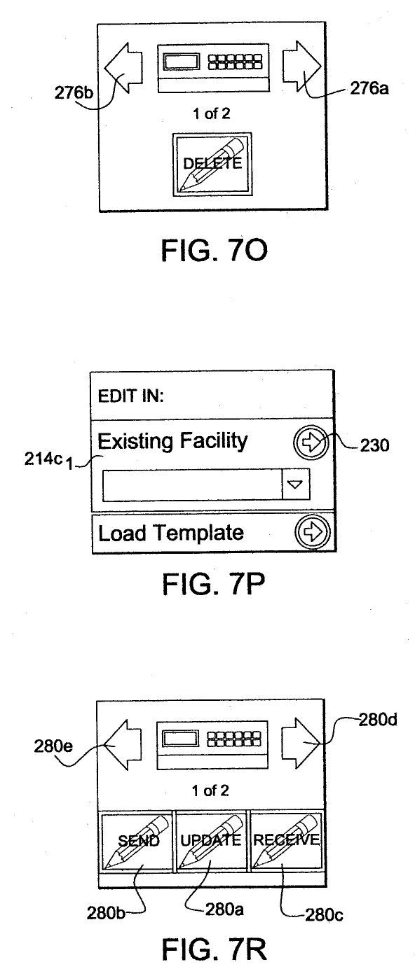

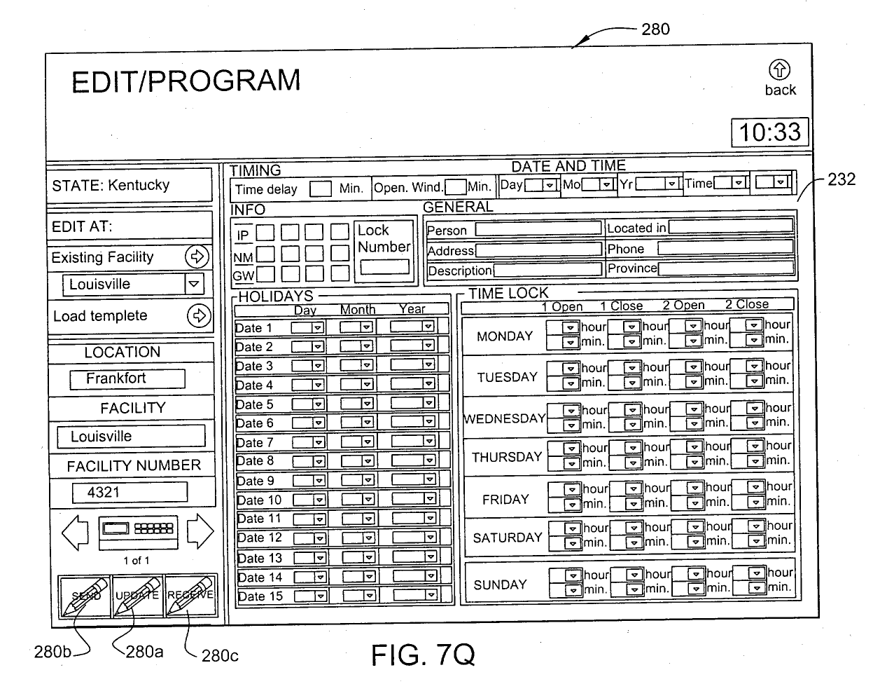

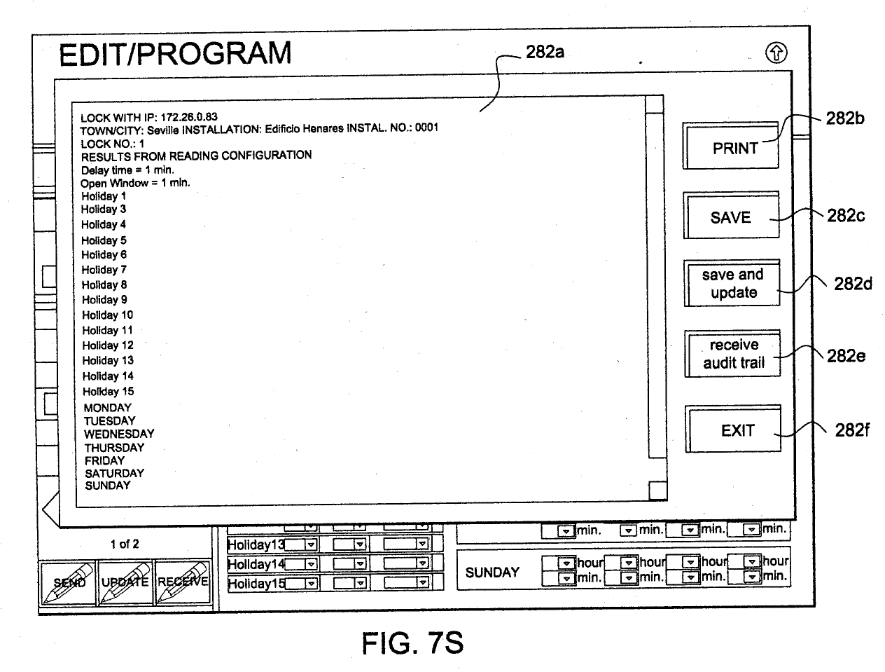

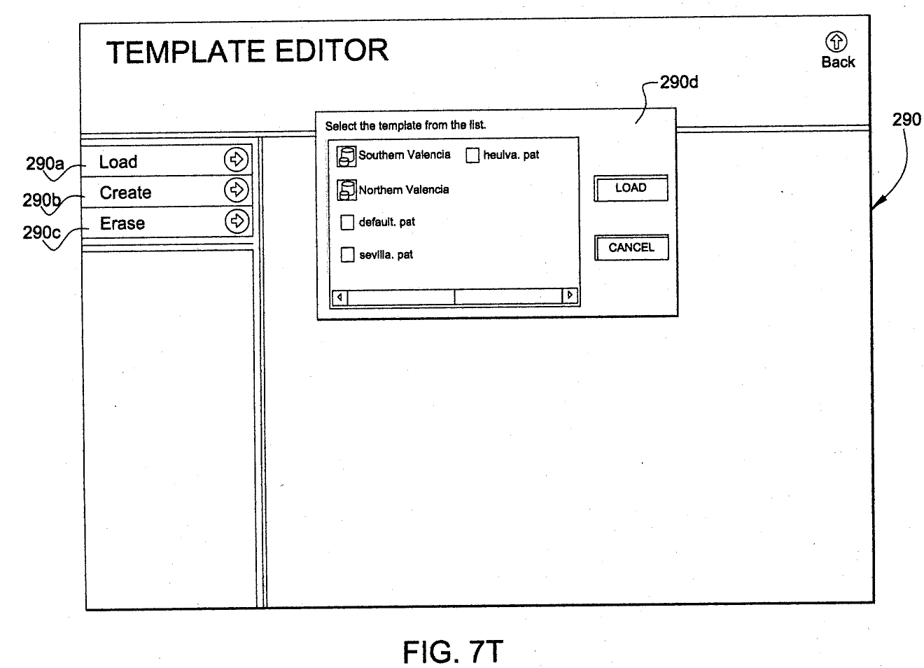

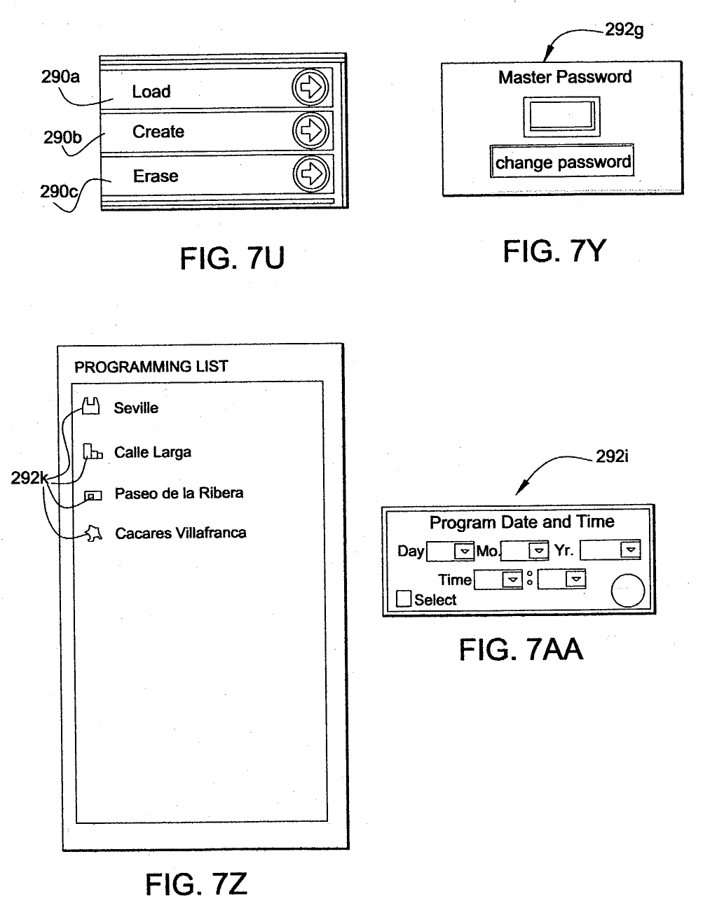

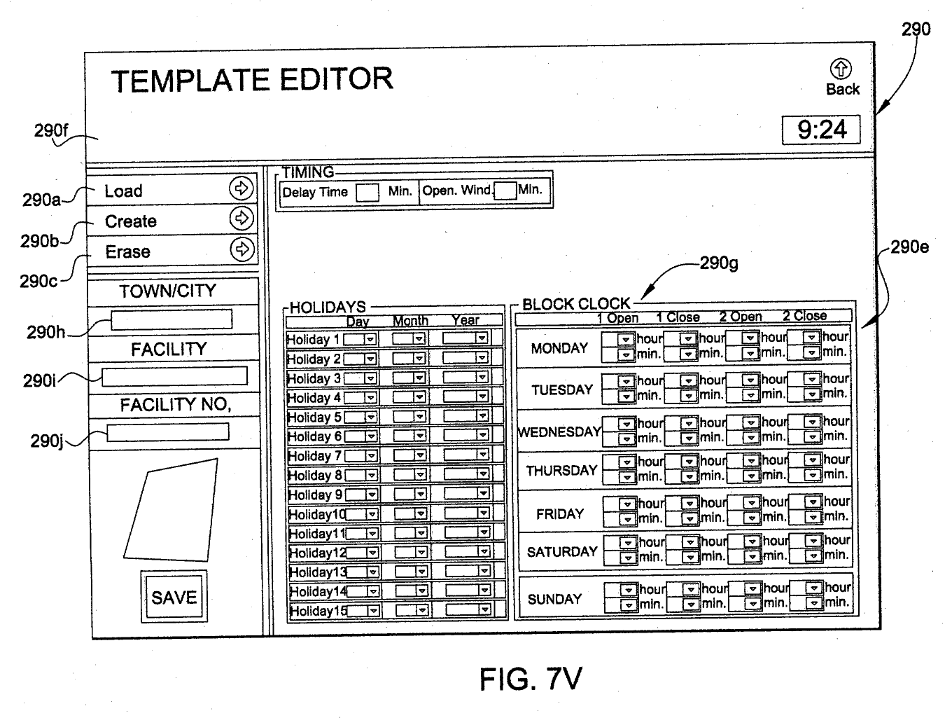

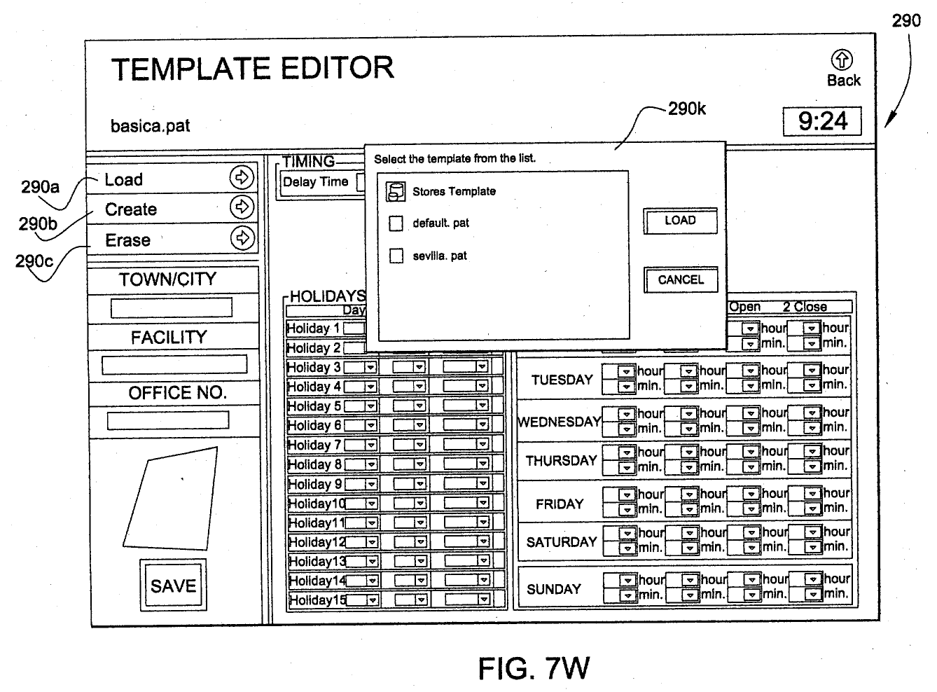

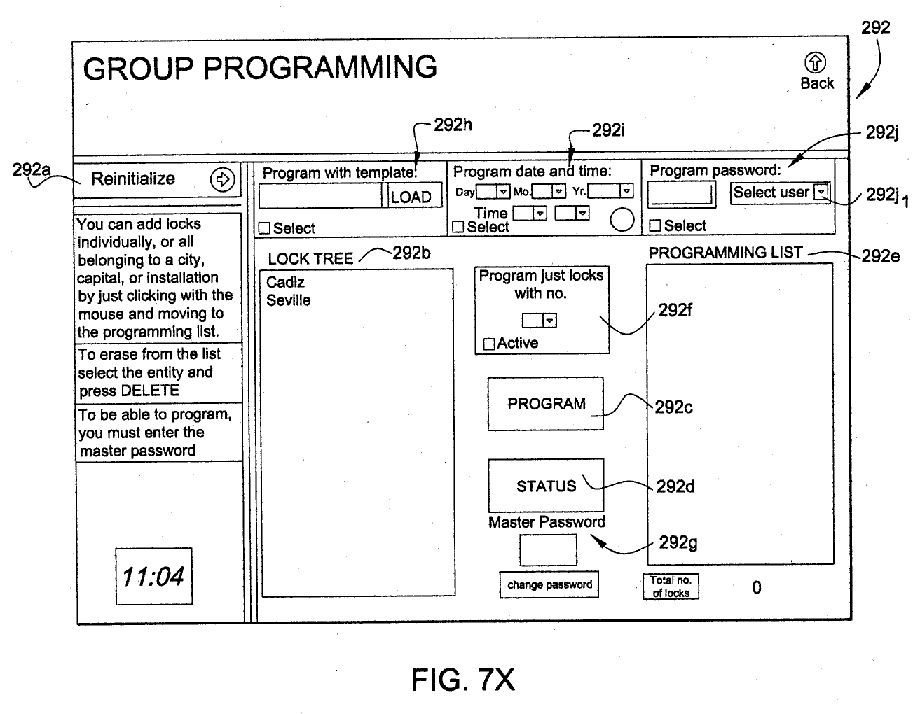

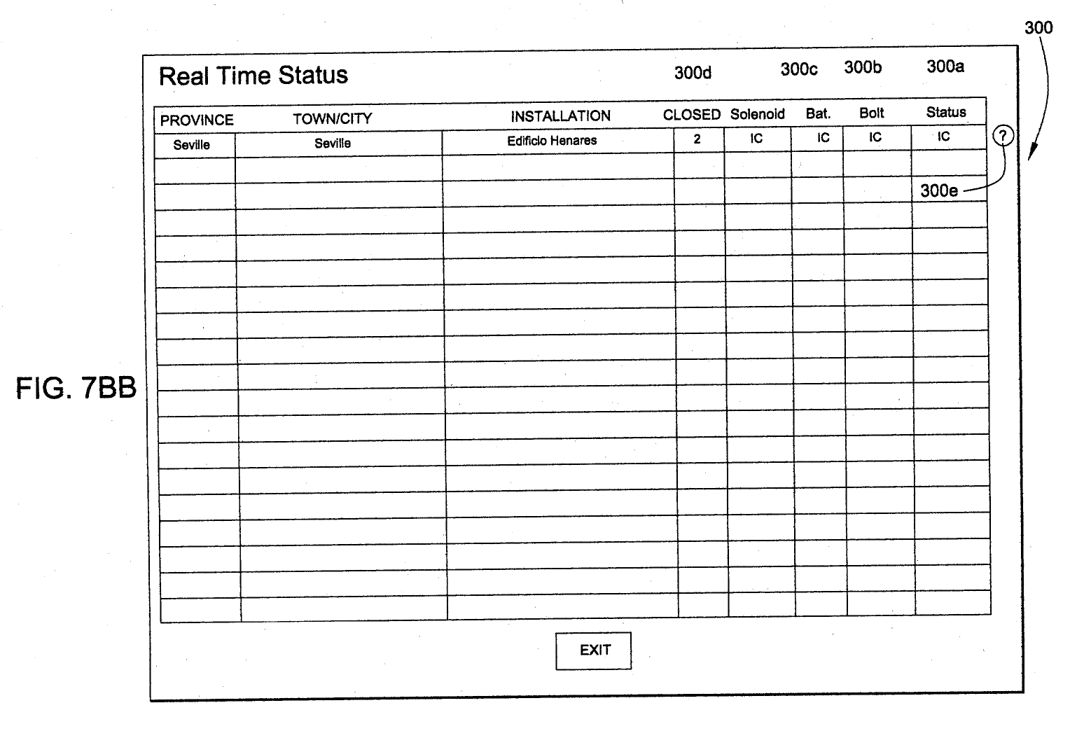

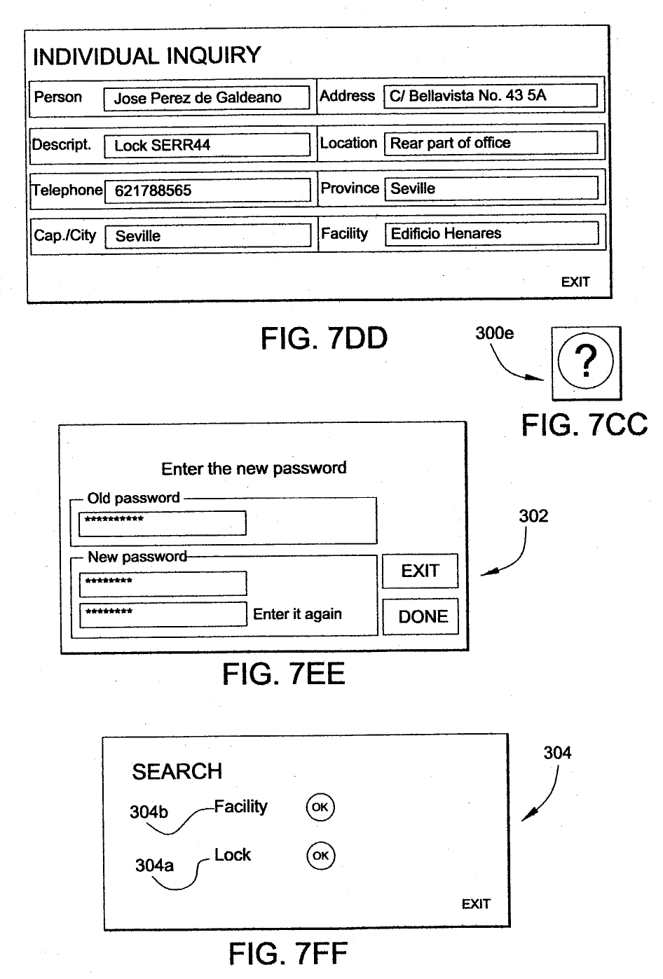

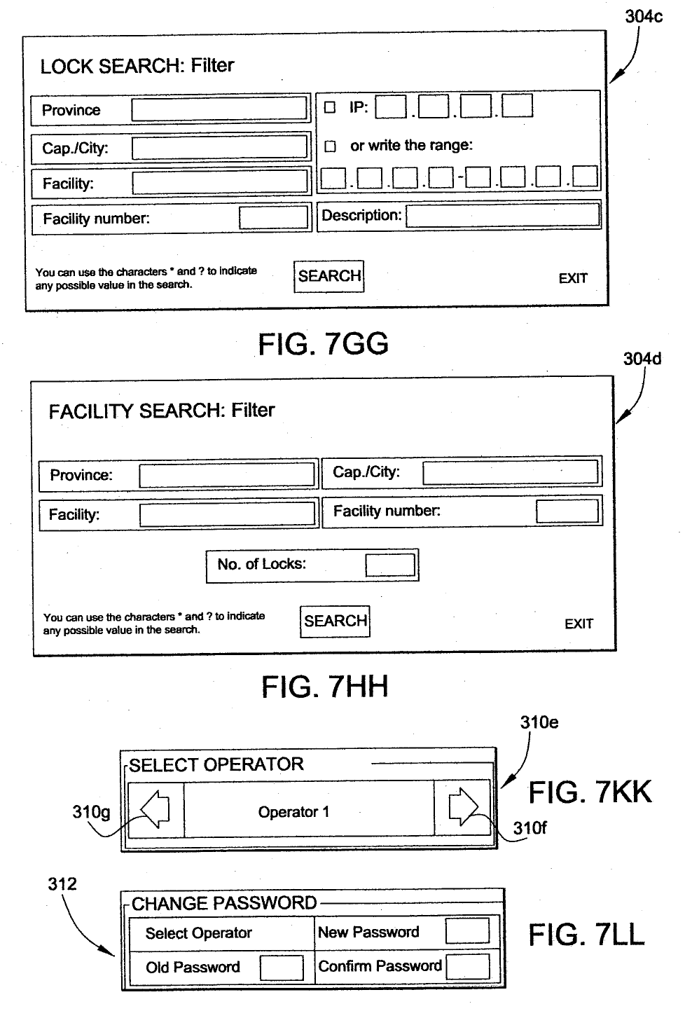

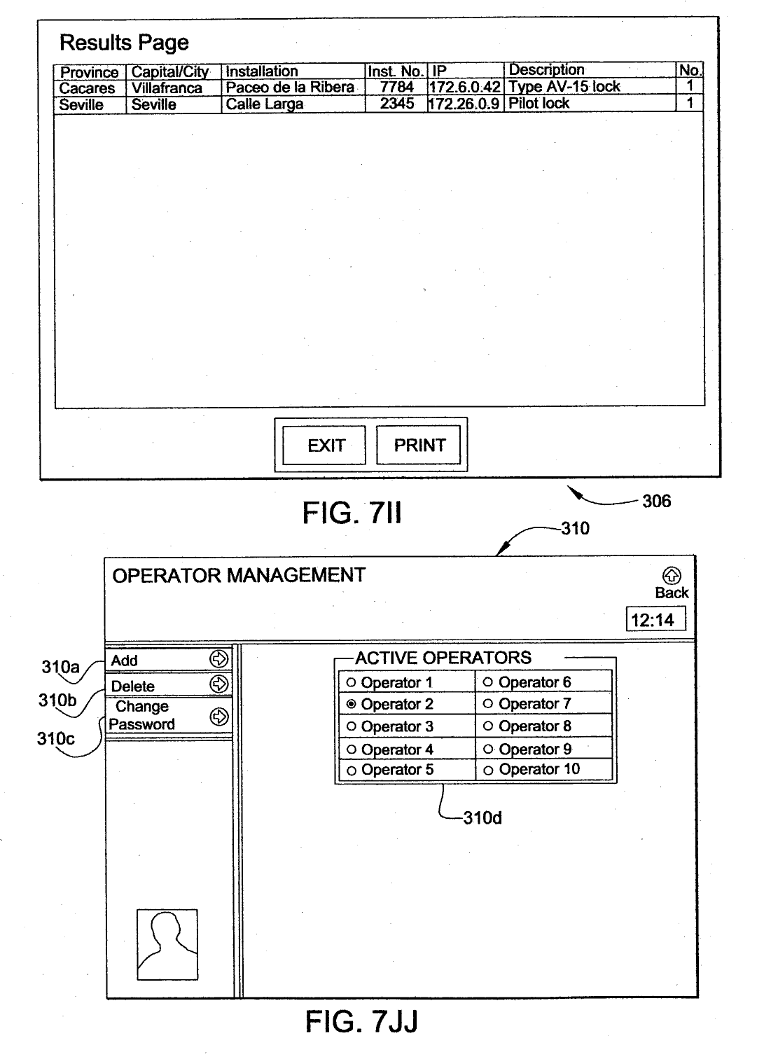

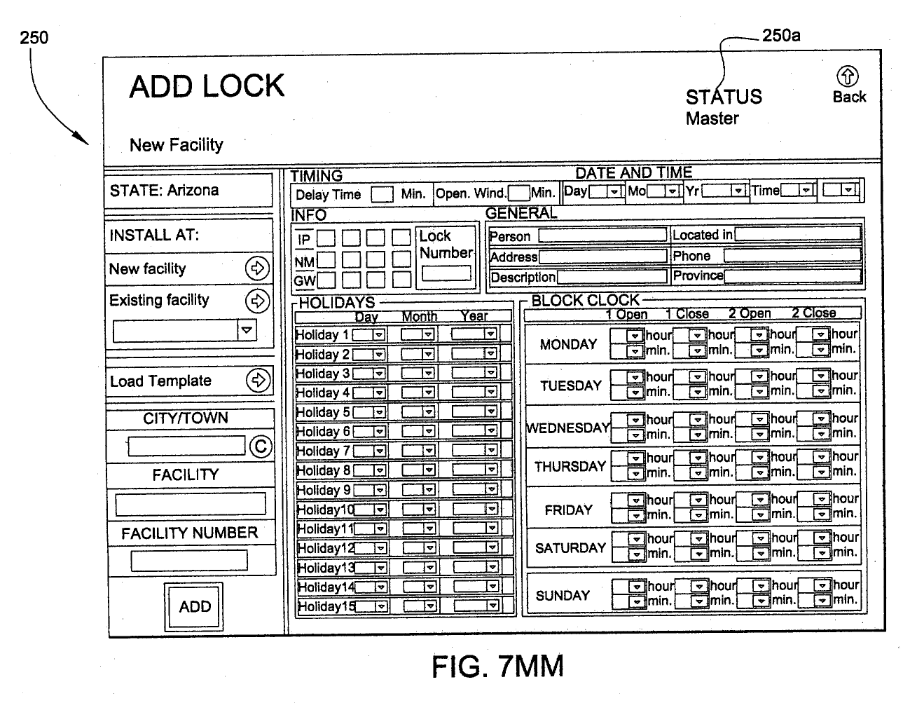

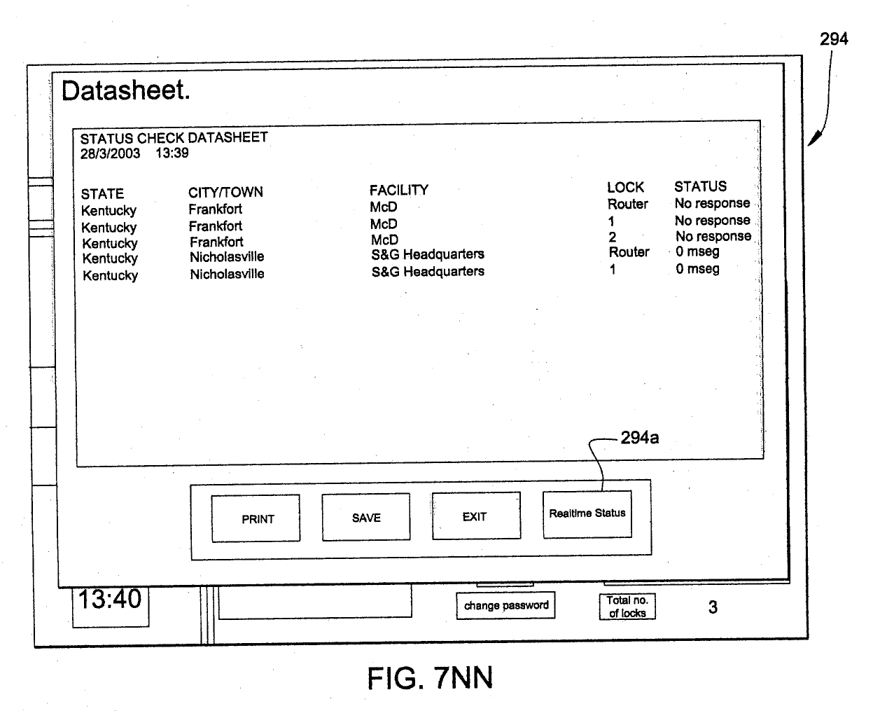

FIG. 7A shows the main menu page 200 that is displayed when the user enters a valid password. The upper part displays the title 202 of the page (or screen) being displayed, and also a button 204 (shown here as an arrow icon) that allows the user to exit to the operating system. This design recurs in all lock management program pages, the arrow icon serving to return to the previous page.

On the left-hand side of the screen are the program browser menus 210, 212, 214, 216, and 220. Buttons 230 allow the user to select access to the options available in each program browser menu. There are five program browser menus (to be described in greater detail hereinafter). Approximately at the center of the screen is a data interaction field 232, which shows a map 234 of the country in which the user is located (in this example, Spain) by region (in this example, province) to enable access to the resources to be controlled. The work zone is defined by clicking on the capital of the province.

Finally, in the lower part of the screen, the user is given two further options 240 and 242: record (backup database), which allows the user to record the lock audit trail file, and recover (restore database)., which enables the user to load an audit trail file to update the current one.

As indicated above, there are five menu options, each with its own field:

Province, Search, Individual Management, Group Management, and Password Management. The functionality of the different options offered will now be described.

An enlarged view of the Province field 210 is shown in FIG. 7B.

Although there are certain pages that a user can access without selecting a region, most of the actions taken by a user in the lock management program require the user to designate the geographical area in which the user is located. The user can select the desired geographic zone by pressing the corresponding capital on the map 234. Once a region has been selected, its name is displayed in the Province field of the menus, as shown in FIG. 7H.

The Search field 212, shown enlarged in FIG. 7C, provides a shortcut for performing certain operations for a specified lock facility. The search field has two data input boxes that allow the user to find the lock facility through one of two possible methods. (1) There is a Facility Number box 212b, into which the user can enter of the installation number and (2) there is a Facility name box 212a, into which the user can enter the facility name. When the user enters the facility number, buttons 230 (shown in FIG. 7D) are displayed that allow the user to access the ADD, DELETE, and EDIT/PROGRAM pages without having specified the province, the data for the locks associated with that facility number appearing in the corresponding page. When the user enters the first few letters of the facility name, the program will offer all the facilities whose first letters correspond to the data provided. When the user clicks on the selected name, the user also can access the ADD, DELETE, and EDIT/PROGRAM pages by pressing the corresponding buttons. When searching by entering the name, the user must first specify the current province.

If the user has selected a province and has used the direct search, the user has already enabled the Individual Management options and their four associated menus 214a, 214b, 214c, and 214d (shown enlarged in FIG. 7D), which are described below. These options work at the facility level, and operate on lock configuration data. The first three require that a PROVINCE field be selected or, in the absence thereof, that a search has been carried out using the facility number or name. The Template Editor 214d (accessed by the TEMPLATE EDITOR button) is a simple editor that allows the user to be able to create templates usable for adding locks and group programming. There are data entry rules both for adding locks (some data entry fields are mandatory) and for creating these templates (for example, certain template data are not necessary, for example it would not make sense to establish INFO or GENERAL fields to program locks; they only make sense for the Manager).

In the Group Management menu field 216 (shown enlarged in FIG. 7E), the user has two types of access to different pages. The first type is group programming (accessed through the PROGRAMMING button 216a). This menu does not require selection of a current province or direct data entry; that is, it is possible to reach a group programming screen directly, just by pressing the group programming button. The group programming options free the user from the task of individually programming all locks, checking their status, changing user passwords, and changing the locks' dates and times, and are described in detail hereinafter. The other type of access is a generic lock and/or facility search engine (accessed through the SEARCH button 216b) that shows by screen those elements that satisfy a series of attributes required by the user. That is, locks can be searched with a specific range of IP addresses, or even those facilities that begin with a specific letter. The conventional filter masks “*” representing any chain of characters, and “?” Representing one single character, are used.

The Password Management field 218 (shown enlarged in FIG. 7F) provides two menu options, one (218a) that allows the user to change his or her personal password for entering the lock management program (accessed through the CHANGE PASSWORD button) and another (218b) that allows the user to manage operator additions and deletions if the user has registered as an Administrator (accessed through the ADMINISTRATOR button). The type of access chosen is up to the user: several operators can be added and several people can be using the application hierarchically, or there can be a single user accessing as an Administrator. At the operator level, the program shows the same options to an operator as to the Administrator, with the exception of the Administrator box, which can be entered only by the latter.

The steps by which the user can add a lock in an existing facility, or create a new facility by generating its first lock will now be described. Selecting the Add button 214a in Individual Management (FIG. 7D) brings up a menu, an example of which is shown in FIG. 7G. The menu has three fields, REGION (or in this example, PROVINCE) 210a, ADD FACLITY 210b, and LOAD TEMPLATE 210c, as follows:

PROVINCE: The current province can be seen in this field.

ADD FACLITY: There are two options 210b₁ and 210b₂ in this field, add a new facility, which will allow the user to add a lock in a facility that is not in the Manager's database (and therefore adding both the new facility and the new lock), and an existing facility, which allows the user to insert sequentially another lock to the locks that have previously been installed. For an existing facility, a drop-down menu 210b₃ allows the user to select the facility to which the user is going to add the new lock.

LOAD TEMPLATE: This option allows the user, after selecting a previously created and saved template, to fill in the fields of the new lock with the template's data.

After pressing the corresponding button on the screen, the lock's configuration data page 250 is displayed as can be seen in FIG. 7H. Some of the fields are mandatory and others follow some simple rules for entering data. An icon or button 252 allows the user to add the new lock to the database, provided that a series of requirements is satisfied and a series of mandatory fields have been filled in.

Initially, in the lower left-hand part of the screen, three fields 254, 256, and 258 are open. The first of them is the TOWN/CITY field 254, corresponding to the city that will house the new facility. If the city is the capital of the province in which the facility is located, a small button 254a (in FIG. 71, shown marked with a C) allows the user to add the province's capital directly without having to type anything. These fields are not case-sensitive, so that if the user types the city name “Nules” and then adds another different facility in “NULes,” the new facility will be added to the first “Nules” created.

The next field is the FACILITY field 256. The lock management program will generate a warning message when the user attempts to add a facility under the same name as an existing facility, so that the user does not repeat names. If the names are the same, the lock management program will delete the prior facility of the same name. If the user does not want the prior facility to be deleted, the user can change its name slightly. Because the alphanumeric data entered is not case-sensitive, “Facility 1” and “facility 1” are the same entity. This allows us the user enter characters such as “:”, “/” and “,”.

The third field, FACILITY No. field 258, allows the user to assign a unique identification number to each facility. In this field, the lock management program is more restrictive, directly deleting the number entered if values for different entities in the same geographical area in the country are repeated. In sum, one facility is differentiated from the rest of the facilities in a country both by name and by number.

In the central-right part of the page, there are six blocks 260, 262, 264, 266, 268, and 270 of data fields—TIMING, DATE AND TIME, INFO, GENERAL, HOLDAYS, and BLOCK CLOCK—which comprise the programming and description of each lock. A large part of these data are resident on the remote elements, and another part is descriptive information at the organizational level, which in no way affects the final behavior of each lock but which is in the local audit trail file.

In the TIMING block 260, there are two fields to fill in, the DELAY TIME field 260a and the OPENING WINDOW field 260b. The DELAY TIME field, for users 1-8, consists of the length of the delay before the lock is going be accessible to the local operator once the local operator enters his or her password. The range of values for the DELAY TIME field is 0-99 minutes. The OPENING WINDOW field is the time that the local operator will have available to open or close the lock once it has become accessible, as required in current regulations. The values for the OPENING WINDOW field can be set between 0 and 99 minutes. Both fields are mandatory to fill in.

The TIME AND DATE block 262 has four fields, a DAY field 262a, a MONTH field 262b, a YEAR field 262c, and a TIME field 262d. The values in the fields of the TIME AND DATE block tell the user the last time the lock was programmed. They are not accessible to the user; the lock management program fills them in with the Operating System's values when launching a programming event (individually in the EDIT/PROGRAM page or in groups through the template application) or updating the audit trail file. When requesting to receive data, the fields in the TIME and DATE blocks are filled in with the date and time values of the lock.

The INFO block 264 has four fields, an IP address field 264a, an NM subnetwork mask field 264b, a GW address field 264c, and a LOCK NUMBER field 264d. The INFO block also requires all its fields to be filled in. The IP address is the IP address assigned to the lock by the network administrator of the LAN to which it belongs. The lock management program will generate a warning message when there is duplication between IP addresses existing on the Internet/Intranet. Likewise, the GW address is the address of the router that acts as a Gateway or border of the LAN with the Internet/Intranet. When the user adds a new facility, possible repetitions of any GW addresses among all the system's LANs will also be checked. Also, the number of the first lock added will always be 1, and cannot be edited by the user. Finally, the NM subnetwork mask will be the mask used on each LAN, but its value is not a determining factor, it is just for information.

The GENERAL block 266 has six fields—a PERSON field 266a, an ADDRESS field 266b, a DESCRIPTION field 266c, a LOCATION field 266d, a PHONE field 266e, and a PROVINCE field 266f—and is the least critical block of all. It is only mandatory to fill in the DESCRIPTION field to provide an idea of the type of functionality for the lock installed. The information stored in this block lets the local user do different types of things. The other blocks are used to program the lock. Their use is therefore optional, except the description field. The PROVINCE field is automatically filled in.

The HOLIDAYS block 268 has DAY, MONTH, and YEAR fields 268a, 268b, and 268c for the date, and fifteen HOLIDAY fields. The HOLIDAYS block is another very important block, although its completion is subject to the geographic area of the facility in question. Holidays can be filled in or not, depending on the number of them, but they can never be partially filled in (only filling in the day, for example). On those days, the lock will remain blocked permanently, the holiday permanent block taking precedence over the blocks programmed for the week (as described hereinafter with respect to the entry of values in the fields of the BLOCK CLOCK block).

An enlarged view of a portion of the BLOCK CLOCK block 270 is shown in FIG. 7J. The BLOCK CLOCK block has a row 270 for each day of the week, two pairs of open and close columns 270b and 270c, and hour and minute fields 270d and 270e (with drop-down menus) for each open and close option for each day of the week. It is the most functional and important of all the blocks. It defines the times when the lock is accessible (Openable). The user must take several rules into consideration when filling in the BLOCK CLOCK block, if the user does not want the lock management program to generate an error message. The first rule is that if the user wants to leave certain fields blank, the user must do so by selecting the blank space, rather than 00, in the drop-down menu. The time 00:00 is not a valid entry for any lock; the earliest time that can be entered is 00:01 and the latest time that can be entered is 23:59. The lock management program also checks the consistency of the data entered (that is, a close time must be prior to an open time) and allows the user to program one single open/close per day without any problem, by filling in the four associated hour-minute fields (however, it matters whether the user uses the second open/close and leaves the first blank), as shown in FIG. 7J. The user also cannot fill in just one hour/minute pair, or three pairs. The program itself will generate an error message if the entered values are not consistent. However, it is permissible to leave the programming for one single day, or every day, blank, at the user's discretion (lock blocked during the day, that is, not accessible).

When the user selects the menu option ADD IN EXISTING FACILITY, the user is presented with an EXISITING FACILITY data entry screen 272 as shown in FIG. 7K. The blocks are the same as in the NEW FACILITY data entry screen shown in FIG. 7H, except that some are updated automatically, in a logical form (such as for example the date and time), because the user is adding a new lock. The most notable changes relative to the NEW FACILITY screen are:

The fields related to TOWN/CITY, FACILITY, and FACILITY No. are fixed and cannot be changed.

The fields related to GW (characteristic of each facility) and to the number of the lock to be added (which is always the next in sequential order) also are fixed and cannot be changed.

The Capital button is disabled.

Once again, when adding, the user is asked whether the user wants to program that lock at that time, after being asked for the Master password. It is preferable for the user to do this, unless the user is planning a group programming a posteriori, because the lock management program will not reflect whether the lock has been programmed before. This is so because the lock is accessible via the Web and locally through the keypad, it being possible to program the lock from a location other than the PC in which the lock management program is resident.

The LOAD TEMPLATE option in the EXISTING FACILITY menu allows the user to fill in the configuration screens through a template file created with the lock management program (as described hereinafter) to avoid having to fill in fields with the same values for locks that have some common connection, for example the same holidays in the same province or city. When the LOAD TEMPLATE option is selected, a menu (shown in FIG. 7L) opens that allows the user to select a template from a list and load it. The template will overwrite the values in the TIMING, HOLIDAYS, and BLOCK CLOCK blocks, as well as the TOWN/CITY, FACILITY, and FACILITY No. fields. The other values will remain intact.

Referring now to FIG. 7N, the method by which the lock management program deletes a lock in a facility will now be described, along with the steps that a user must follow to delete a lock. The entry for a facility can only be deleted from the local audit trail file after all of its locks have been deleted. Its city also will be deleted at the same time, if the facility was the only facility in that town/city (although it is still possible to add another facility again in that same province).

Step 1: The first thing that the user must do is select the facility. For this, the EXISTING FACILITY menu (FIG. 7N) 272 has a drop-down menu from which the user selects the facility that houses the lock to be deleted. The user then presses an enter button.

Step 2: After the facility (site location) has been selected, the configuration data (including the locks that are housed in the facility) is displayed to the user in the data interaction field 232, as shown in FIG. 7N. The user selects the lock from among those housed in the facility, using forward and back navigation buttons 276a and 276b (shown enlarged in FIG. 70).

Step 3: Finally, the user presses the DELETE button 278 (shown enlarged in FIG. 70) to delete the lock. At this point, the lock management program renames all the locks belonging to the selected facility, so that they are again sequentially numbered, that is to say, if lock number 4 of a total of 7 was deleted, the fifth lock one will now be number 4, the sixth lock will now be number 5, and the seventh lock will now be number 6.

The Edit/Program page 280 (FIG. 7Q) will now be described. The Edit/Program page is useful when the user has made a mistake when entering values into any configuration field or when the user simply wants to change any specific datum. Not all values will be modifiable, as will be described below. There are three options in the Edit/Program page: (1) updating, (2) sending, and (3) receiving, with corresponding buttons 280a, 280b, and 280c.

The Edit/Program page is also the page that is used for programming a particular lock with the data the user has filled in. It is possible for a lock to be included in the local database (the local audit trail file) with all its fields filled in, and that a programming event for the remote lock has not yet been launched. This is why when any value is changed, the lock management program asks whether the user wishes to launch that event at that time, to avoid possible inconsistencies among the local information in the PC and the control device.

To compare the local data (in the remote lock management program) with the lock's real data, there is an option to receive the control device configurations (that is, the data associated with TIMING, DATE AND TIME, HOLIDAYS, and BLOCK CLOCK), which can subsequently be used to update the local database, record them in a file (recap.log) or which can be printed with a preselected operating system printer. Likewise, a request can be launched to receive an event audit trail, also allowing it to be printed and/or saved in a file a posteriori.

To access the Edit/Program page 280 (FIG. 7Q) from the menu, the user must first choose a current province or locate the current province by doing a search. The user then pushes the Edit/Program button 214c on the menu of the front page (FIG. 7A) of the lock management program, which causes a drop-down menu 214c, (shown enlarged in FIG. 7P) to be displayed for selecting the existing facility that houses the lock to be edited. The drop-down menu is similar to the menu for selecting an existing facility (FIG. 7G) or deleting a lock (FIG. 7M). In the drop-down menu, the user selects the facility he or she wishes to access, by pressing the corresponding ENTER button. At that time the Edit/Program page is opened on that screen, and the user is authorized to use template loading if deemed appropriate. The template will only overwrite the values TIMING, BLOCK, and HOLIDAYS.

To be able to Update a configuration page for a lock, a user only has to fill in the corresponding field. The rules for filling in fields described above in connection with Adding a New Facility must be followed by filling in each of the blocks (TIMING, HOLIDAYS, etc.). The GW address for each lock should not be changed unless the router address is changed.. Nor are the DATE and TIME modifiable (because they are updated automatically), or the lock number, or the TOWN/CITY, or the name of the Facility or its number (for obvious reasons, because those values would imply adding new entities and facilities).

The selection of the lock is analogous to the prior examples, using the corresponding forward and back navigation buttons 280d and 280e (shown enlarged in FIG. 7R) in the selected facility to select the lock to be edited. Once the lock has been selected, the user presses the UPDATE button 280a.

The process of sending information is initiated by pressing the send button 280b (shown enlarged in FIG. 7R). For this, the programmer tries first to connect to the control device to access the lock. The lock management program is capable of determining whether there was connection with the lock but it was not programmed, and it is also capable of knowing whether it was successfully programmed because there is confirmation between the PC and the control device. Furthermore, every time a user launches a programming event, the user will be asked for the Master password. The Master password entered by the user will be used to validate the connection between both machines over the network. Likewise the DATE and TIME are also updated with the Operating System values if the programming is done correctly.

If the user launches a programming event prior to updating the values, the lock management program will update the audit trail, provided the connection and programming are done automatically. Otherwise the new values will be lost when the user exits the page with the “back” button.

The last of the options that are provided on the Edit/Program page is to launch a data receipt request event. A data receipt request event can be used for configuring the control device (to check on screen the values with which the lock is programmed) and an audit trail of up to 1,000 events. As with the other options, the desired lock can be selected with the forward and back navigation arrows (FIG. 7R), and the receive option is initiated by pressing its associated button 280c.

In this case, when a connection cannot be established with the lock, the lock management program will ask whether the user wants to test the status to determine whether the associated control device has “crashed.” A short dialog box (not shown) will show the result of the application, once again, of a ping of the control device's (lock) IP address.

The first thing the lock management program does is receive the configuration data 282a from the lock and show them to the user (FIG. 7S). The user can then print the configuration data on a printer, save them in a file, save them and also use them to update the database (a very useful option) and, finally, request the event audit trails by pressing associated buttons 282b, 282c, 282d, and 282e. If the receive audit trail button is pressed, the screen will refresh with the events received, retaining the functionality of the print and save buttons (in another file by default), and disabling the save and update button because they are unavailable at this time. The exit button 282f returns the user to the Edit/Program page.

The generation, editing, and deletion of templates will now be described with reference to FIGS. 7T-7W. The ability to edit a template provides convenience when filling in data for locks or by permitting group programming of previously added locks; and speeds up and simplifies the process of assigning values for configuration, just like the systematic program of multiple locks with the same values in HOLIDAYS, BLOCK CLOCK, and TIMING.

The template editor 214d is one of the Individual Management options on the main menu (FIG. 7D). Pressing the Template Editor button causes the Template Editor page 290 (FIG. 7T) to be displayed. The Template editor menu includes three options, (1) Load, (2) Create, and (3) Erase (shown enlarged in FIG. 7U). The options can be selected by clicking on their associated buttons 290a, 20b, and 290c.

By selecting the Load option, a template load dialog box 290d (FIG. 7T) is displayed in the central part of the screen. The user can press Load at any time, even if the user is in the middle of creating a new template (the user might, for example, want a new template based on an another, old template).

If the user just clicks on the Load option button, the load interface will appear without the background template data (see FIG. 7T). As discussed above, the template file must have a template extension and be in the local current directory or in a subdirectory of the current directly. Once a template file is selected, the page with all the current configuration data 290e that the template is going to have will appear in the central part of the screen, as shown in FIG. 7V.

When selecting the template, the template's edit page will appear as shown in FIG. 7V, where all the fields are displayed so that the user can begin to add data. The name 290f of the current template loaded appears on the screen. The user can access the file or even browse the subdirectories by double-clicking, but for security reasons, the user can never exit the facility directory.

Every time a user clicks on the button for the Create template option, the page is updated by erasing all possible values from the fields and also erasing the name of the current template, if it was loaded in order to be modified or was previously recorded. The template name will only appear if the user has performed any of these actions; its name does not appear until it is recorded or loaded.

The following considerations must be kept in mind when editing templates: (1) The user can create an entirely blank template, although such a blank template will lack any functionality whatsoever. (2) In the BLOCK CLOCK block 290g, the data entry rules are the same as those for adding or changing locks, as previously described. However, the other values may be filled in however the user wants; that is, unlike the previous cases, when editing templates the user can only place one open window, etc. When templates are used for group programming (as discussed in greater detail hereinafter) whose configuration fields do not have values, the user will have to be careful, because an error will occur if the blocking times are not filled in. (3) Templates must always be saved with the template extension; otherwise, the lock management program will generate an error message. (4) When storing a new template, the name will be updated in the upper left-hand part of the page. (5) The values of the TOWN/CITY field 290h, FACLITY field 290i, and FACILITY No. field 190j are also editable (although defining them for a template which is to be applied to several facilities makes no sense).

When the Delete template option is selected, a dialog box 290k as shown in FIG. 7W will appear. The user selects the file to be deleted and then clicks the “erase” button 290c on the screen or the “delete” key of the keyboard. As with the other template menu options, only the fields that the program recognizes as templates will appear, that is, files with the template extension. It is also possible to delete a subdirectory in the current directory, although it is not possible to do this if it is not empty.

The Group Management menu will now be described. This menu simplifies the process of updating the values for previously ADDED locks. This implies not that the user is going to have to add a number of locks at the same time, but rather that the user can change the programming in the fields that he or she wants for a number of locks at the same time.

Because the Group Management feature acts on fully networked groups (as will be discussed in greater detail hereinafter), the lock management program is very simple and flexible. By adding locks (by dragging and dropping) to a group to be managed, the user can generate programming events en masse, and even test the connectivity of entire LANs (including the routers themselves), as well as viewing in real time the status of up to ten locks at a time.

The Group Programming page 292 when first accessed from the main screen is shown in FIG. 7X. The only option that the user can see is the REINITIALIZE option 292a. If the user presses the associated button, the page will reinitialize its values (that is, it will erase any previously entered values).

As shown in FIG. 7X, the page is divided into several zones. In the left-hand zone is the so-called lock tree 292b, which has a tree structure that organizes access to the locks hierarchically, as shown in FIG. 6. The user selects a lock from the tree structure. The user then must choose one of two action buttons: the PROGRAM button 292c or the STATUS button 292d. For the action buttons to have functionality, the programming list 292e must also contain something. Above the action buttons is a filter 292f for applying programming choices to locks that have a number assigned in each facility.

The MASTER PASSWORD field 292g (shown enlarged in FIG. 7Y) is at the bottom of the central zone. The master password is required both to validate any type of lock programming and to verify its status. The lock management program will generate a warning message if the master password field is not filled in. As discussed in greater detail hereinafter, the master password can be changed.

Finally, there are three selection blocks 292h, 292i, and 292j for the three modes of programming, (1) programming by template, (2) direct programming of date and time, and (3) programming of user password changes (discussed below). Only one of these blocks can be activated at one time, which is done by clicking on a button associated with each block. The programming is done basically the same way in all three modes: the locks to be programmed are determined by using the selection tree for example by clicking with the mouse. The user can select one lock, a facility, a capital/city, or a province. After selecting, the user can drag the selected object (that is, a lock, a facility, a capital/city, or a province) to the programming list with the mouse or press the associated “select” button.

FIG. 7Z shows how the objects on the programming list are added.

When adding objects higher in the hierarchy, all the locks belonging to the selected object are incorporated into the programming list automatically. Thus, if a lock is added in a facility and then the city in which it is located is added, the lock icon disappears from the list, because it is included in the city and will continue to be included in the programming, and it is not necessary to repeat its presence on the list.

Objects appear on the list with an icon 292k that represents the type of object (a lock, a facility, a capital/city, or a province), as well as their names, the location of the facility, the facility number, and the capital/city, if necessary to know where each one is located.

When the user believes that the list is ready, the user checks the “select” box in each mode of programming and presses the associated icon. The results of the programming selections are displayed on a page and can be printed and/or saved in a file.

Programming with templates consists of applying a template previously created by the template editor in the lock management program itself. The only configuration blocks that must be kept in mind in this mode are the TIMING, BLOCK CLOCK, and HOLIDAYS blocks. The other configuration blocks are ignored by the lock management program. Although some templates are valid to add locks (they can have empty fields), others are not valid for group programming. That is, they must have the field in the TIMING block properly filled in (the fields in the HOLIDAYS and BLOCK CLOCK blocks can be left blank without a problem, because the fields in the DATE AND TIME block are filled in automatically by the lock management program with the system date and time).

In sum, when the user presses the load button, the user sees a template load dialog box similar to that in FIG. 7T. Once the template is selected, its name will appear in color, and the user will then be able to launch the programming event.

The DATE AND TIME programming mode 292i (shown enlarged in FIG. 7AA) allows the user to update the dates and times of all locks on the programming list with a single click. The user fills in whatever fields the user wants (if the user does not enter anything in the field, nothing in the lock will be changed) and the user selects the selection box. The user also has the DATE AND TIME button available, which updates the date and time of the current operating system.

The PASSWORDS programming mode 292j allows the user to change the passwords of the user chosen in the drop-down menu 292j₁ for all locks on the list. The new password will only have numeric characters and a fixed length of 6 characters. Duplicate passwords may be accepted without an error message.

Verifying the lock status is an action that is useful in certain cases. For example, sometimes communicating with the lock is not possible due to the fact that the user cannot connect to the lock in question. This inability to connect to the lock can have several causes, the diagnosis of which, in most cases, is beyond the capacity of the lock management program. However, it is possible that a LAN's router has “crashed,” and that the locks work perfectly well. This situation can be verified by verifying the status of the lock, or by discarding this option if the router responds to the ping and the malfunctioning lock does not.

Also, the user might be interested in checking the physical status of several locks simultaneously. The user can perform a physical status check for a maximum of nineteen locks at one time; if the maximum of nineteen locks is reached, the lock counter appears in color, indicating that a real-time request is not allowed (the icon for the results page is disabled when the STATUS button is pressed).

The lock management program, when it is programmed to verify the status of locks added to the list, automatically checks the LAN router to which they are connected. The sequence of steps to follow is exactly the same as when the user wants to launch a programming event: (1) filling in the programming list, (2) entering the Master password, and (3) pressing the status button.

Once the status verification event is launched, and the different protocols are carried out, a window appears similar to the window for group programming, but the file generated by recording the log has a different name. The file generated by recording the log is a text file, and can be viewed with any program capable of reading a text file, such as Windows® WordPad. The status request can be launched in real time for those locks whose connectivity has been verified, and the status button for making the status request is accessible from the lower part of the new window.

As previously described, it is possible to monitor the status of up to nineteen locks in real time (if this number is exceeded, the lock management program would disable this option). Monitoring the lock status in real time is very useful if the user wants to verify when the bolt is being opened, whether the solenoid is activated, etc. To monitor the lock status, the user need only launch a status request (using button 292d) from the group-programming page (see FIG. 7X) and from the results page 294 (FIGURE NN), press the REAL TIME button 294a again. Requests will only be produced for those locks that successfully pass their connectivity test.

In response to the selection of the REAL TIME button, a table (shown in FIG. 7BB) is displayed to the user, which includes the origin (Province, Capital/City, Facility, and lock number) of each supervised event, as well as four status fields, the STATUS field 300a, the BOLT field 300b, the BATTERY field 300c, and the SOLENOID field 300d

STATUS: Defines the connection status of the lock. There are several different values for STATUS: (1) Normal: Lock with no timing status; (2) Delay time: Lock in delay time; (3) Open window: Lock in open window; and (4) Penalty time: Lock in penalty time.

BOLT: Defines the lock's bolt status. There are three different values for BOLT: (1) Open: Bolt open; (2) Closed: Bolt closes, typical situation; and (3) Open/Closed: Transitional status.

BATTERY: Defines the status of the circuitry's internal battery. There are two different values for BATTERY: (1) Good: The optimum status is detected; and (2) Low: It is a good idea to change the batter.

SOLENOID: Defines the activity of the lock's solenoid. There are two different values for SOLENOID: (1) Active and (2) Inactive

The lock management program generates requests every three seconds. When no answer is received from the remotely-located control device, a type of security counter is put into action, which expires after seven seconds. A code (“IC”) then appears in the status boxes indicating “In Connection,” that is, the protocol is in the process of recovering from the bi-directional communication. If the code remains on the screen for a long time, there is a communications problem and the corresponding qualified technical person should be called.

A small icon 300e (shown enlarged in FIG. 7CC) is displayed on the right-hand side of each row. This icon allows the user to access a small inquiry page (shown in FIG. 7DD) with more specific data, such as, for example, the contact person if any anomaly is noted in the behavior, or the description that is in the database.

The master password that the lock management program requests MUST BE THE SAME as the one the remote locks have. That password acts to validate the bi-directional communication via TCP/IP, which is why it is continuously requested every time the user starts a session of this nature.

FIG. 7EE shows the CHANGE PASSWORD box 302 that appears when the user presses the change password button. As is conventional, in the CHANGE PASSWORD box, the user is asked to type in the old password once and to type in the new password twice. There is a file in the current directory that saves a value different from the password, but which the file management program uses to determine the currently valid password. That file cannot be corrupted or deleted.

Once the new value is entered, the application launches a programming event for all locks in the audit trail file. Changing the master password requires that the control device and the remote lock management program be synchronized.

The functionality of the lock and facility search engine will now be described. This search engine is a results search engine based on some filters on the most significant fields of the previously discussed objects (PROVINCE, TOWN/CITY, FACILITY, FACILITY No., IP ADDRESS, DESCRIPTION, and LOCK No.). The Group Search utility is accessed from the main screen (FIG. 7A), using the SEARCH option on the GROUP MANAGEMENT menu. Upon pressing the SEARCH button, a first dialog box 304 (FIG. 7FF) is displayed for the user, in which one of the two possible objectives (“Facility” 304b or “Lock” 304a) can be chosen: search for groups of locks or groups of facilities. Once one of the two search objectives is chosen, the user is shown filter entry boxes 304c and 304d for fields characteristic of each search objective (see FIGS. 7GG and 7HH). To query the database (which at this time is in the PC's memory), the user fills in the fields that the user thinks appropriate and launches the search. If all the fields are left blank, the lock management program will then show ALL locks/facilities in effect at that time.

After the search is completed, a results page 306 (shown in FIG. 7II) will be displayed with tables in which each row will contain the results corresponding to the search conditions. Pressing the fixed column in the first row causes the lock management program to sort the results displayed alphabetically. The user also can print the tables.

As has been previously described, a user can access the lock management program when launching the program by registering as an Operator or Administrator. Initially, no operator is active, and the only user with authority to use the application is the Administrator himself. The initial password is a default password that the Administrator can change.

The use of Operators as other possible users is at the discretion of the system's beneficiary entity. It is possible not to add any Operators, or to restrict use of the lock management program to just one person. The lock management program allows a maximum of ten operators.

Accessing the Change Password option from the first page causes a dialog box 302 such as shown in FIG. 7EE to be displayed. This box allows the user to change his or her personal password for the program; it is not related to the Master Password (programming password) that the user must enter every time the user interacts with the lock. The Change Password option is the same for the Operator and the Administrator.

The Administrator option on the main page shows the user the Operator Management screen 310 (FIG. 7JJ). Use of the Operator Management screen is restricted to the Administrator. From here the Administrator can add or delete different Operators, as well as change their passwords.

Immediately on entering the page, the screen appears as in FIG. 7JJ. On the left-hand side there are the three available options 310a, 310b, and 310c: Add, Delete, and Change Password, each of which has an associated button. In the center, there is a table with the ten Operators and a button to the left of each. When the button is active, then that operator is active.

When the Administrator presses the button associated with the Add option, a Select Operator menu 310e appears in the middle of the screen (FIG. 7KK), from which the Administrator can select the Operator to be added. Navigation buttons 310f and 310g permit the Administrator to scroll through the possible candidates to be added. If all the Operators have been added, a dialog box (not shown) will so inform the Administrator. When the Administrator presses the Add icon, the new Operator will be added with a default password, which is also shown in a dialog box (not shown).

The Delete option is carried out analogously to the Add option. If the Administrator presses the delete option, a menu (identical to the menu shown in FIG. KK) appears in the middle of the screen, from which the Administrator can select the Operator to be deleted. As with the Add option, navigation buttons permit the Administrator to scroll through the possible candidates to be deleted. When the Administrator presses the Delete icon, the Operator will be deleted.

When the Administrator presses the Change Password option, two menus are displayed. One of them is the Select Operator 310e as shown in FIG. 7KK, and the other is a Change Password menu 312, shown in FIG. 7LL. The Change Password menu enables the Administrator to enter new passwords for operators. As is conventional, the Administrator must enter the old password once and the new password twice, and then press a CHANGE button in order for the password change to take effect, provided that everything is correct.

As previously described, there are two configurations of the remote lock management system in accordance with the present invention, a basic, directly-connect configuration (shown in FIG. 1A) and a hierarchical, master/slave configuration (shown in FIG. 1B). In the directly-connected configuration shown in FIG. 1A, all the locks on the network have the same behavior. If a user wants to program a certain control device, then he or she must continue doing so through the local keypad, connecting to its Web page, or launching the corresponding command from the lock management program.

There are very few differences between the lock management programs of the directly-connected and the master/slave configurations. Only three pages are different. The rest of the lock management program continues to retain its interface and functionality in both configurations. The lock management program must know at all times what type of lock it is interacting with, particularly when the lock is being programmed, because the programming blocks that are sent to the control device include additional configuration data if the lock is a master-type lock, and these data are required for the system to operate correctly.

The first substantial difference is that in the master/slave configuration, there is an additional characteristic or attribute for each lock: It can be a master or a slave. As can be seen in FIG. 7MM, this characteristic will appear in text 250a in the upper right-hand part of the screen, on the ADD, DELETE, and EDIT/PROGRAMMING screens.

In the master/slave configuration, the lock management program will always assign the master attribute to the first lock that is added to the facility. This means that Lock No. 1 of each LAN will always be the master, and the rest of the locks (numbers 2, 3, 4, etc.) will be the slaves. This convention is useful if, for example, the user wants to program only the masters in a province from the group programming page, just by putting the even application filter on the locks whose number is 1. In this sense, the lock management program is very strict, it not being possible to assign the master status to a lock with the number 2.

For the user, the management of this feature is absolutely transparent. The screen merely includes an additional field, [master]=yes/no on the data page, in the working file.

In the master/slave configuration, the ADD attribute is updated automatically. If the user presses “new facility,” “master” will appear in the upper right-hand part of the screen, indicating that this lock will centralize Web accesses by client machines on the network. If the user presses “existing facility,” the user is going to add a new facility starting with the first, and will always be adding slave locks.

The main change on the DELETE screen in the hierarchical configuration is that it requires the last lock to be deleted to be the “master.” This is because, when the lock management program deletes a lock, it sequentially reorders the numbers, so that if the first lock is deleted, it will assign the status of master to the second, this configuration being incorrect because each lock has a different program in its associated control device.

The associated number also cannot be changed in the EDIT/PROGRAM screen of the master/slave configuration and, therefore, its master/slave attribute cannot be changed either.

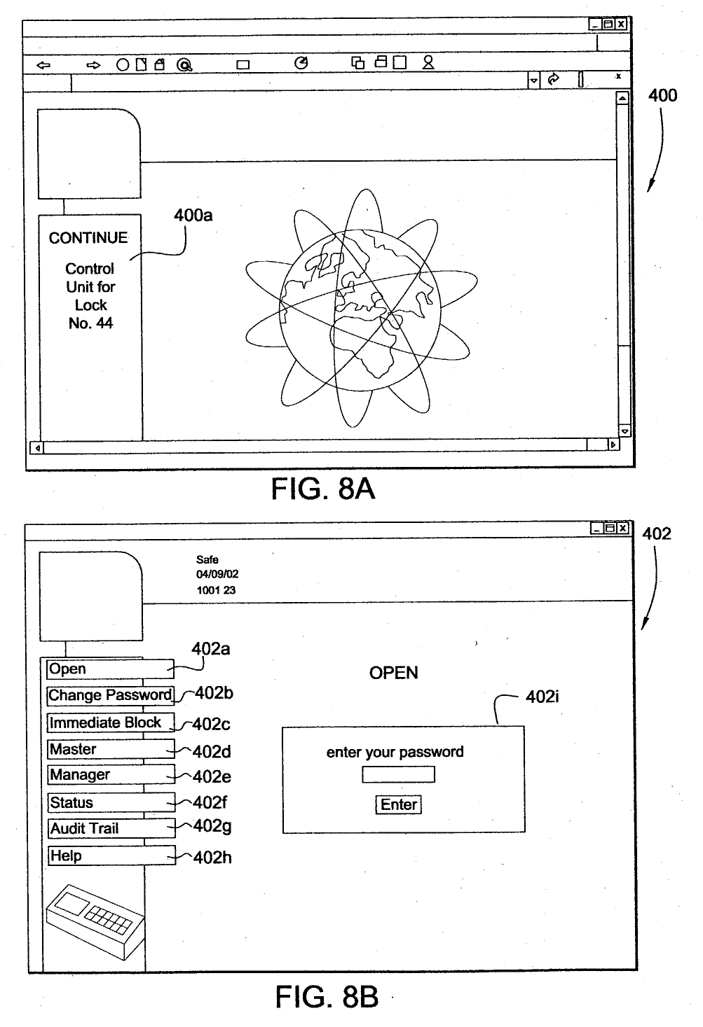

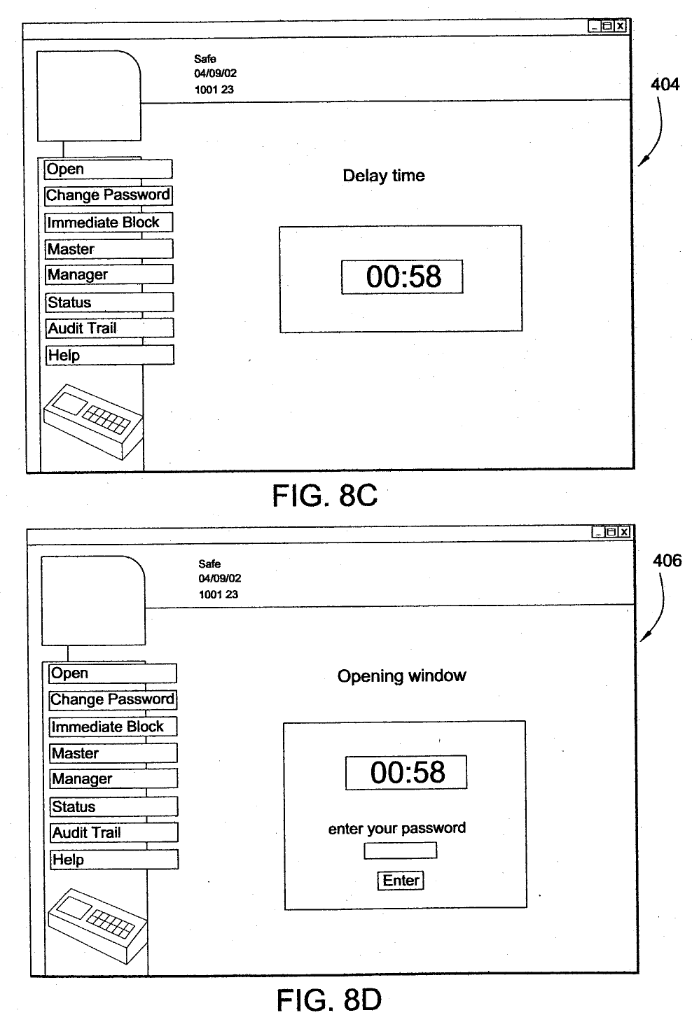

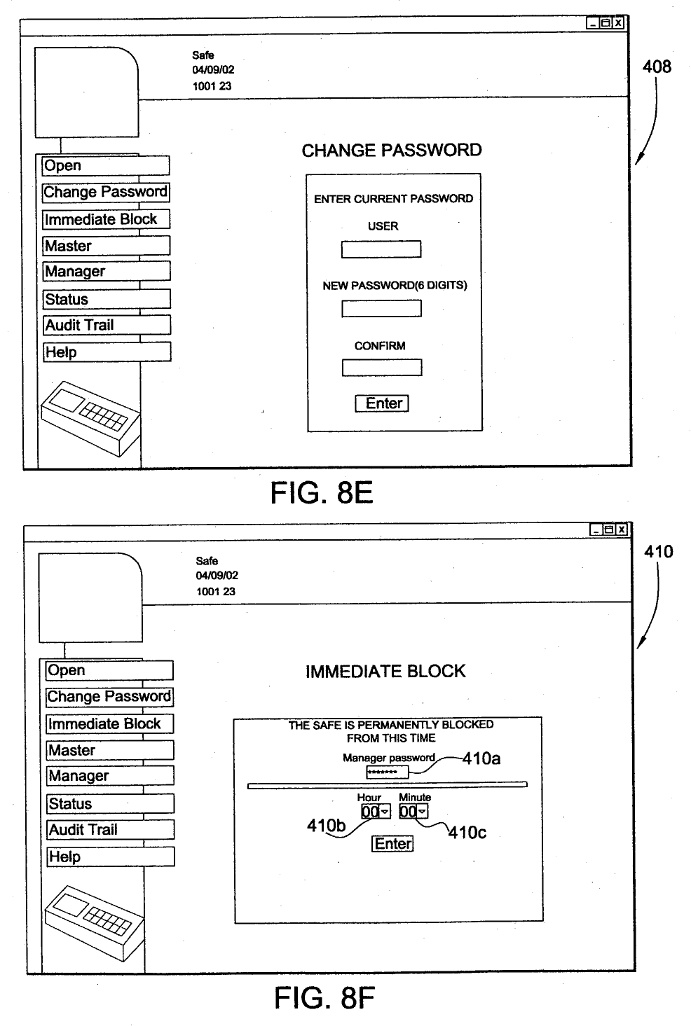

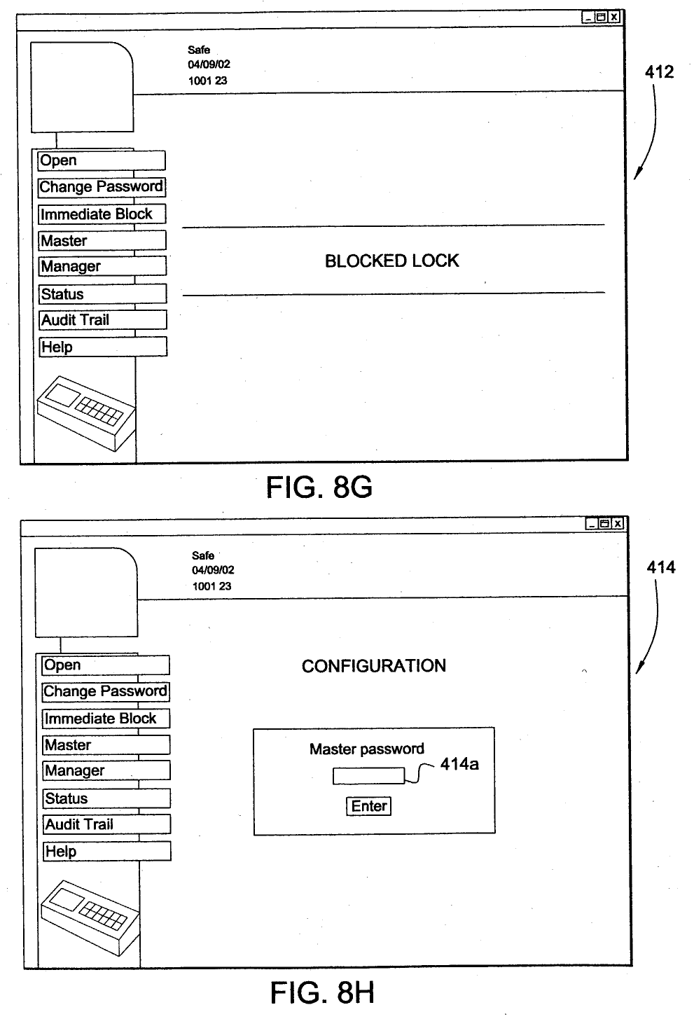

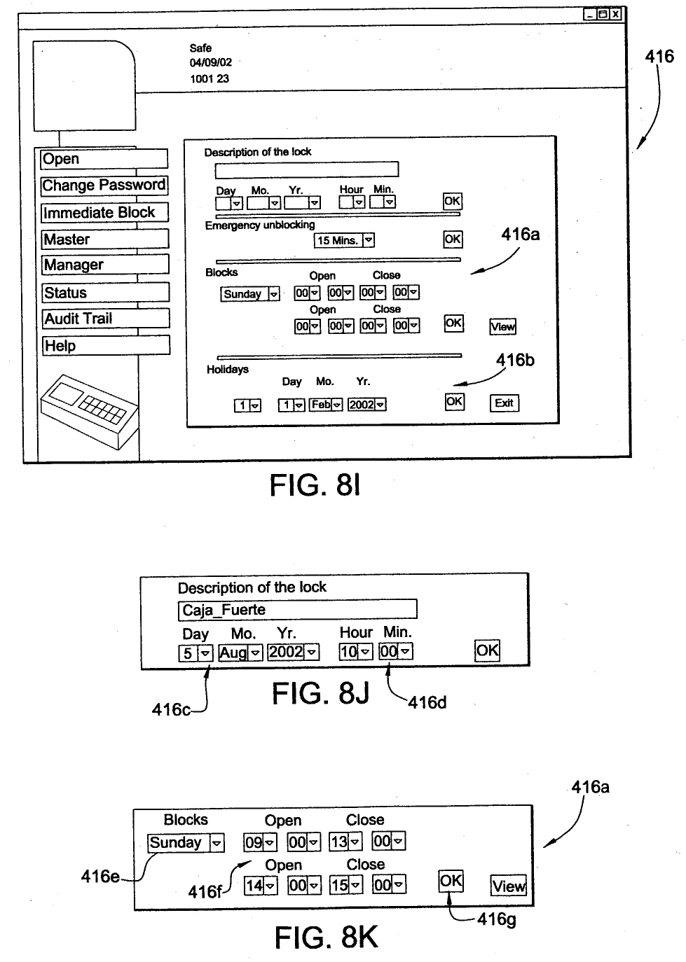

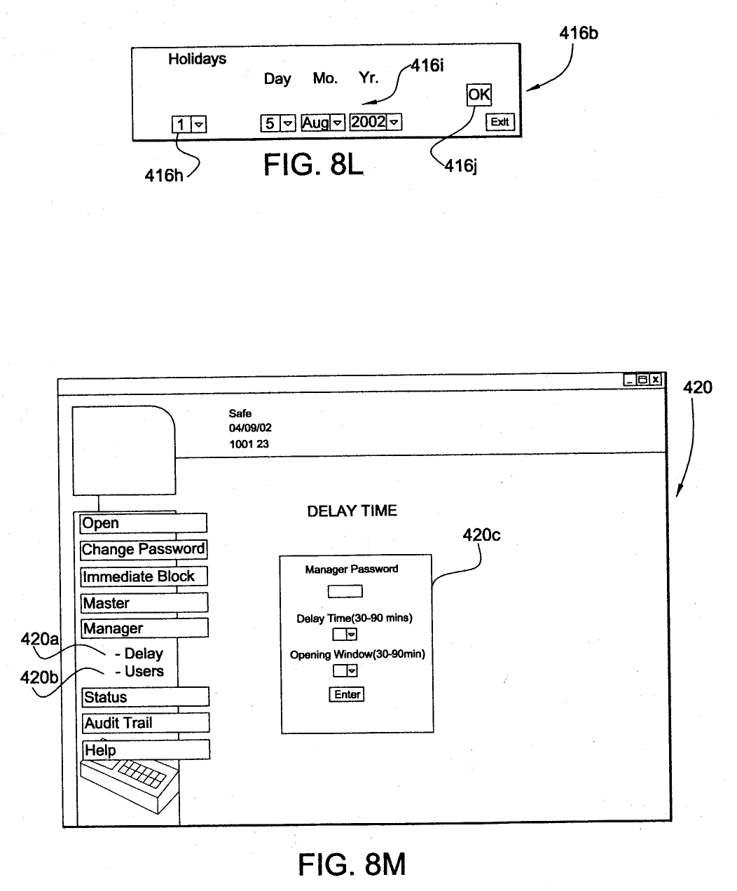

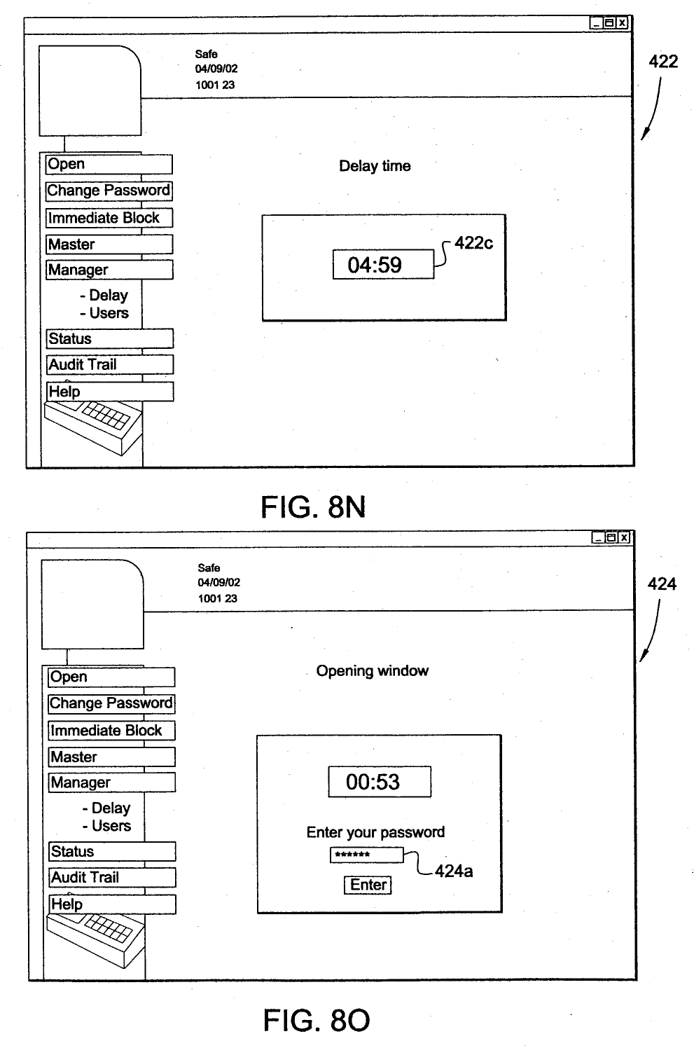

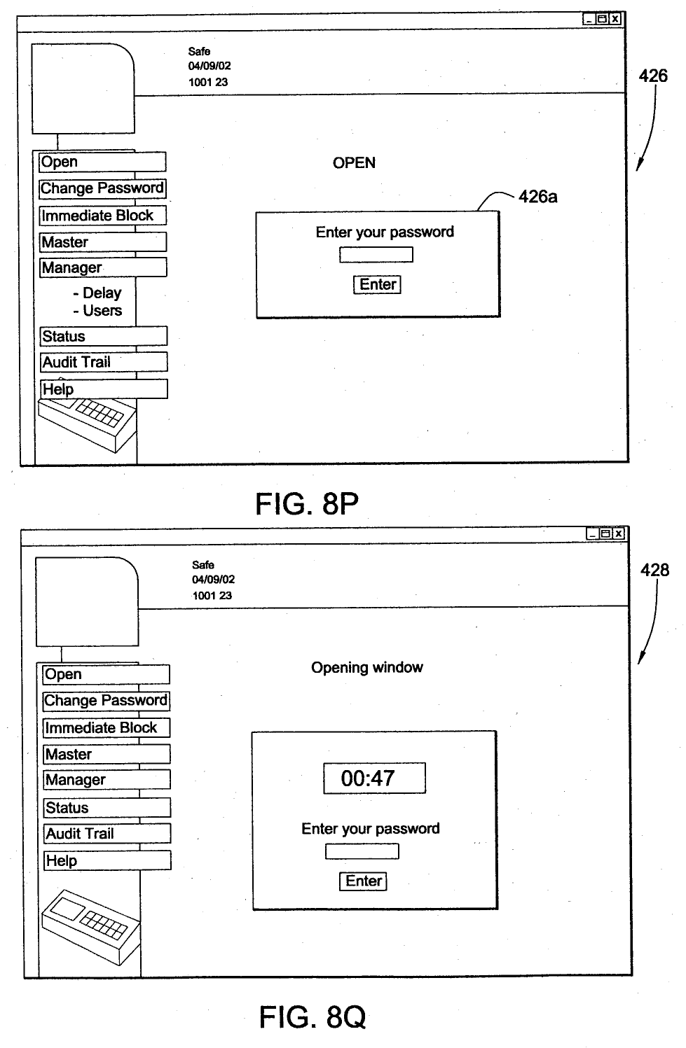

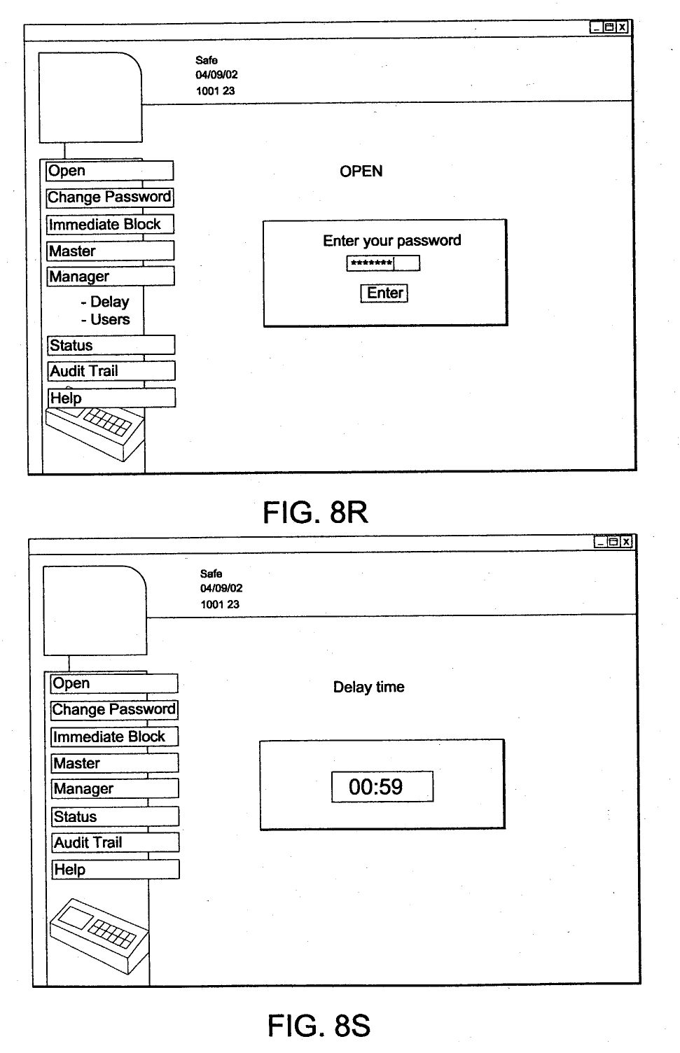

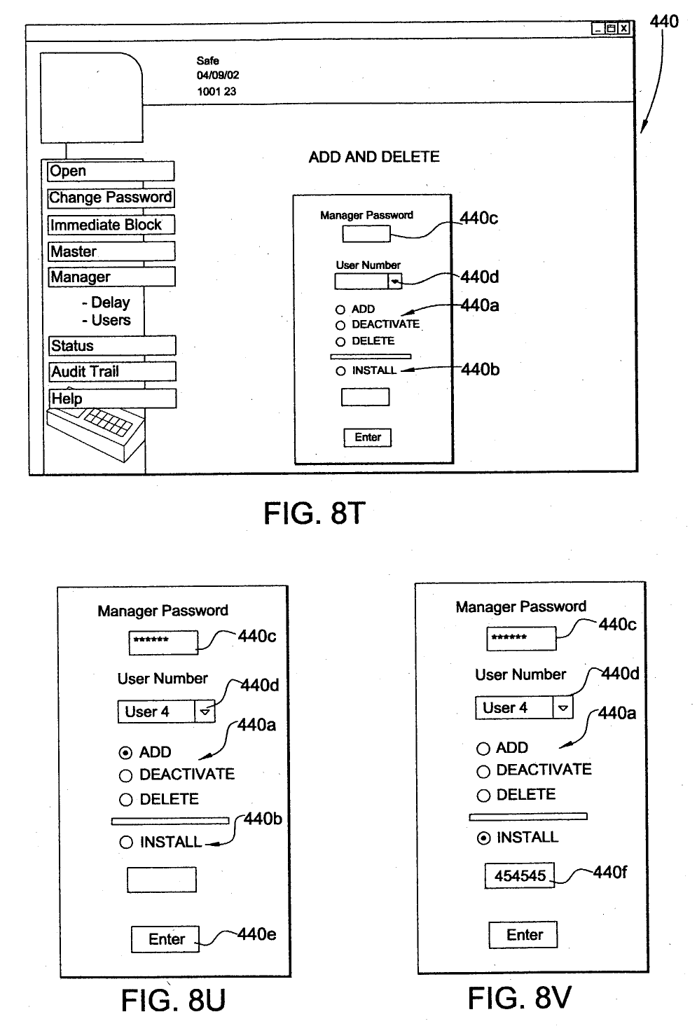

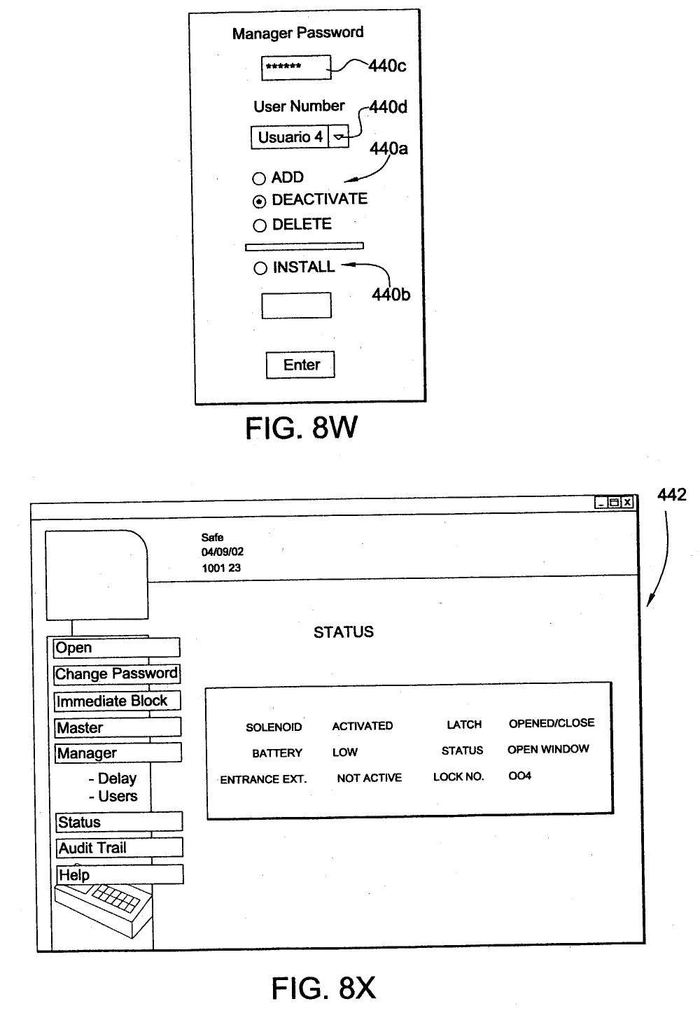

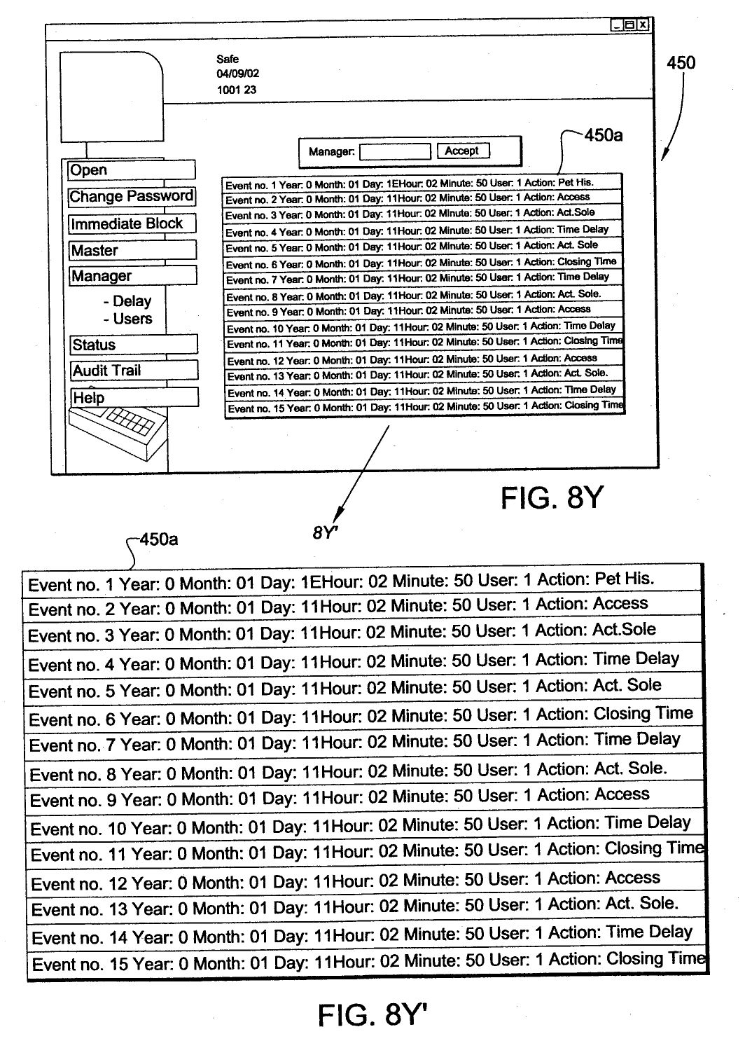

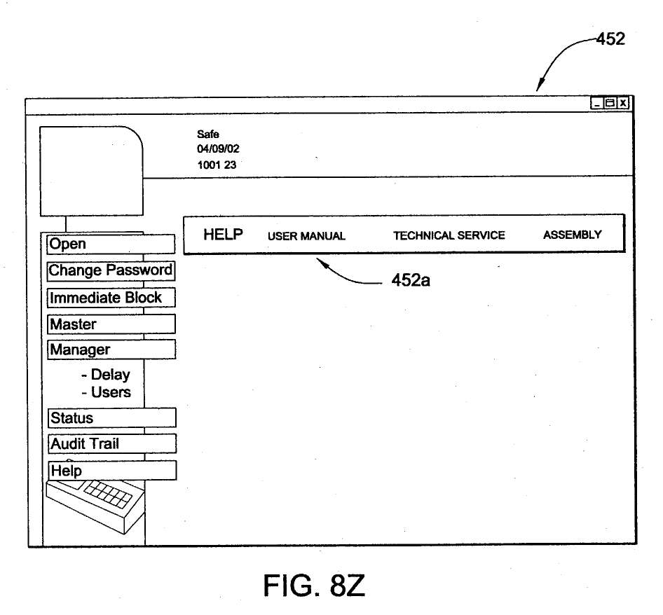

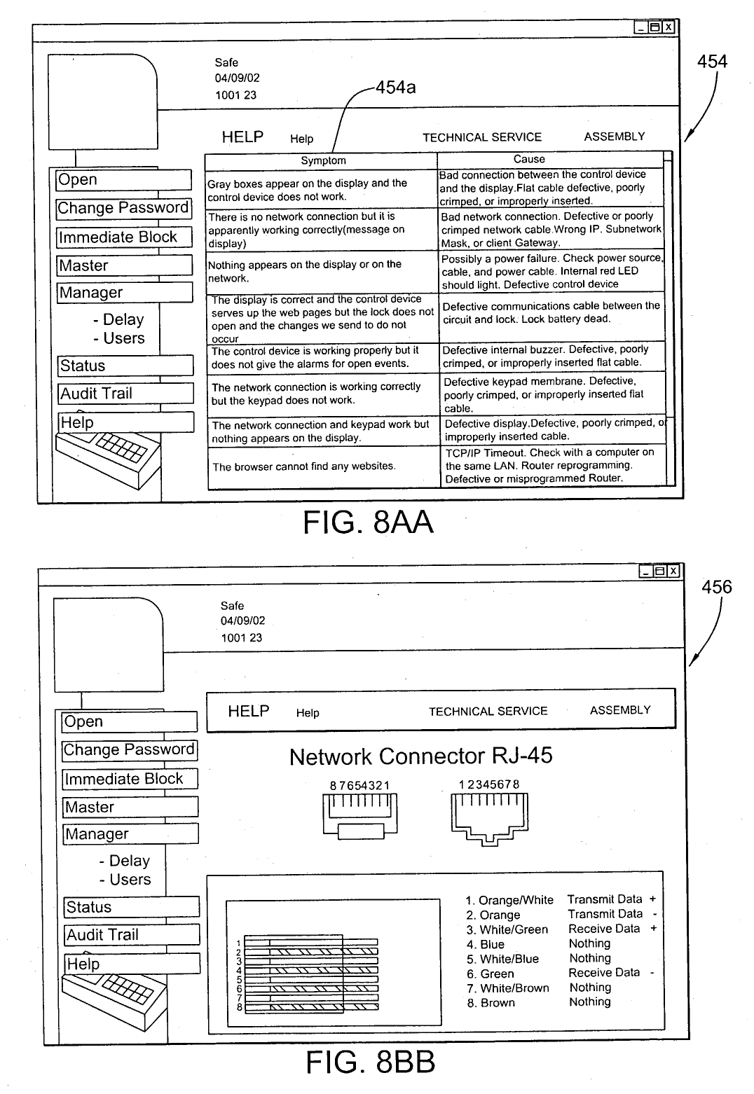

The remote management of a lock through the control device in remote mode will now be described. Once the user has launched his or her Web browser and put the control device's IP address in the address bar, a Web front page 400 will load on the user's computer monitor, as shown in FIG. 8A. As will be appreciated by those of skill in the art, the Web pages shown in FIG. 8A and succeeding figures are exemplary only, and can be varied as required for a particular application. The user selects the front page “Continue” button 400a to enter the lock's Web management Web pages.

The initial lock management page is the Open page 402, shown in FIG. 8B. The open page includes an options menu with the following options for managing the control device: (1) an Open option 402a; (2) a Change Password option 402b; (3) an Immediate Block option 402c; (4) a Master option 402d; (5) a Manager option 402e; (6) a Status option 402f; (7) a History (audit trail) option 402g; and (8) a Help option 402h. In order to perform any of the first seven functions, the user must enter his or her password in a Password window 402i.

From the Open page, the user can select the Open option 402a to order the control device to request its associated lock to open. The control device will process the order, and if the user is authorized, it will load the corresponding Open Lock Web page 406 (shown in FIG. 8D) at the end of a set delay time, which is displayed in a Delay time window 404 (FIG. 8C). The Open Lock Web page requires the user to enter his or her password within a certain amount of time, as shown in FIG. 8D). If the user is authorized, the control device will activate the lock's internal solenoid, causing the lock to open. The control device also will emit a sound to notify other users near the lock that the Open Lock function is being allowed.

If the user is not authorized, the control device will detect the unauthorized attempt to access the lock and will load a corresponding Access Denied Web page (not shown), notifying the user that access has been denied and than an incorrect password has been entered. While in the Access Denied Web page, the user is allowed three more attempts to enter the correct password. On the fourth incorrect attempt, the control device causes the lock to enter a penalty time, during which the lock is locked for one hour and is not accessible in any way, either locally (through the associated keypad) or remotely (via the Internet).

The Change Password option allows the user to change his or her password. To accomplish this, in accordance with conventional practice, the user is presented with a Change Password Web page 408 (shown in shown in FIG. 8E) requiring the user to enter the old password once and the new password twice, as. If the old password is incorrect, or if the first and second entry of the new password do not match, the Change Password command will not be carried out and the user will again be presented with the blank Change Password Web page.

The Immediate Block option allows a user to block access to a lock immediately, until a time specified by the user, provided that the user knows the Manager password. The Immediate Block Web page 410 (shown in FIG. 8F) has a field 410a for entry of the Manager password and fields 410b and 410c for entry of the hour and minute at which the block is to be released. If anyone tries to request opening of the lock during the period when the block is in effect, a Blocked Lock Web page 412 (shown in FIG. 8G) will load, advising that the lock is blocked.

The Master option is only accessible by a designated Master user, and allows the Master user to set the control device's clock, define windows when the lock is not blocked (configure weekly timelock), and define holidays (there may be a pre-set maximum, for example, 15). The Master option also allows the Master user to define special times when the lock is not blocked, to allow a short, unblocked time window to be opened for a specific emergency. The Master Entry Web page 414 is shown in FIG. 8H, and requires the user to enter the Master password in a Master password field. If the Master password is correct, the Master Menu Web page 416 (FIG. 81) is loaded.

The Master Menu Web page has fields 416a and 416b (shown enlarged in FIGS. 8K and 8L) for the Master user to enter any blocking or holiday period when the internal program will begin to compare the time on the control device's clock the blocking or holiday period. For example, the Master user can initially configure the control device with a date 416c and time 416d as shown in FIG. 8J. If the Master user wants an unblocking window on Mondays from 9:00 a.m. to 1:00 p.m., and from 2:00 p.m. to 3:00 p.m., the Master user enters the day 416e and times 416f as shown in FIG. 8K. When the Master user selects “Ok” button 416g, the control device will start checking every few seconds whether the current date and time correspond to the unblocking window that has been set. If, for example, the day is Monday, but the current time is not within the unblocking window, the control device will enter an unblocking period, and it will not be possible to request the lock to open.

Similarly, if the Master user wants to define holidays, he or she only has to complete the holiday number and date fields provided for that purpose, as shown in FIG. 8J. When the Master user selects “Ok,” the control device will check every few seconds whether the current day is one of the holidays that has been entered. If so, when a user attempts to request opening the lock, the Blocked Lock Web page 412 (FIG. 8G) will load, advising that the lock is blocked. It is noted that by default, the control device will be blocked if no time period is entered.

The Manager option has two sub-menus, the Delay and User sub-menus 420a and 420b (shown in FIG. 8M), and allows any task associated with the person in charge of maintaining and managing passwords (that is, the Manager) to be performed. Using the User sub-menu, the Manager can add, disable, delete, and install users on the system. Using the Delay sub-menu, the Manager also is able to change the delay time and the open window.

An example of the use of the Delay sub-menu to decrease the time delay and the open window (where, for example, the time delay and open window have previously both been defined as 5 minutes) will now be described. The Manager can only perform this task during the opening window.

First, the Manager selects the Delay sub-menu, causing the Time Delay Web page 420 to load (FIG. 8M). In the Delay sub-menu, the open times can only be changed if the correct Manager password is input into a Manager Password field 420c. When the correct Manager password is input, a Time Delay Countdown Web page 422 (FIG. 8N) will load, and will display a countdown 422a of the previously set 5-minute time delay. After the 5-minute time delay has passed, the Open Window Web page 424 (FIG. 80) loads, and the Manager has a certain amount of time to enter his or her password in a new Password field 424a.

If the Manager has entered the correct password, the control device will activate the lock's internal solenoid, allowing the lock to be opened. The Open Request Web page 426 (FIG. 8P) will load, and the Manager must input his or her password in another new Password field 426a. When the correct Manager password is input, the Time Delay Countdown Web page (FIG. 8N) will load again, and display a countdown of the previously set 5-minute time delay. After the 5 minute time delay has passed, an Open Window Web page 428 (FIG. 8Q) loads, which will allow the Manager to update the delay times.

In the Open Window Web page 428 (FIG. 8Q), the Manager enters the updated times in a time field 428a and his or her password in a password field 428b. When the Manager enters a valid password, the control device will send a command to decrease the open window time. In a new Open Web page, the new times will now be displayed (FIGS. 8R and 8S).

The User sub-menu will now be described. When the User sub-menu is selected, an Add and Delete Web page 440 (FIG. 8T) is loaded. The Add and Delete Web page offers the Manager two options with corresponding fields 440a and 440b: (1) adding, deactivating or deleting a user, or (2) installing a user. For either option, the Manager must enter a valid Manager password in a Manager Password field 440c and select a user number (from a User Number dropdown menu 440d) to which the option will apply.

Initially, the control device is provided with all the users erased. To give permission to a user, the user must first be added, and then installed by defining his or her password. To perform this task, as shown in FIG. 8U, the Manager enters the Manager password, selects the user number from the dropdown menu (in this example, User 4) and the “add” sub-option, and then selects the “enter” button 440e. The Addition and Deletion Web page then reloads, and as shown in FIG. 8V, the Manager enters the Manager password, selects the user number again, selects the “install” option, enters the password for the user (in this example, 454545) in the user password field 440f, and selects the “enter” button.

The process for deactivating and deleting users is similar to the process of adding them. If the Manager wants to deactivate a user without deleting him or her, the Manager enters the manager password, selects the user number, and selects the “deactivate” sub-option (FIG. 8W). Deactivation will result in the user's open request being denied. A user can also be deleted with respect to a lock by selecting the “delete” sub-option instead of the “deactivation” sub-option.

To re-activate a user who has been deactivated, the Manager opens the Addition and Deletion Web page and “adds” the user, without also “installing” him or her. To re-activate a user who has been deleted, the Manager opens the Addition and Deletion Web page and both “adds” and “installs” the user as described above.

The Status option allows the user to see in real time the lock that the user is addressing. While the Status button on the main menu is activated, the system will request the status of the lock every few seconds, and will display it on a dynamic Web page 442 (FIG. 8X). The dynamic Web page gives the user the status of the internal solenoid, the bolt, the battery, the system setting status (delay time, open window, penalty window), as well as telling the user the status of the external input (digital I/O). The lock number is for reference, that is, each lock is defined by an IP address.

The audit trail option allows the user to request an audit trail directly from a lock. To access this option, the user must input the Manager user password. When this is done, the control device makes a request to the lock. There is a short delay while the request is made and the audit trail records from the lock are displayed on the Web page. As shown in FIGS. 8Y and 8Y′ (FIG. 8Y′ being an enlargement of the area 8Y′ in FIG. 8Y), the audit trail displayed on the Audit trail Web page comprises the last n events stored in the lock itself (n being 15 in the example of FIGS. 8Y and 8Y′). Each event comprises the year, month, day, hour, and minute since the lock was connected, displayed in descending chronological order (that is to say, the events higher in the list are the most current), and information on the user password that generated the event in question and the action that user has performed.

The Help option 402h provides both users and installers of the control device with information for addressing various problems. As shown in FIG. 8Z, this information is accessed from the Help Web page 452 through a series of hyperlinks 452a, which allow the user or installer to request the User's Manual, Technical Service, and Installation instructions.

The Technical Service main Web page 454 (FIG. 8AA) presents a chart 454a of problems and causes that will allow the user to determine the cause of a possible equipment malfunction.

The Assembly section provides support for the installer if any type of problem or question arises related to, for example, the connector pins, the network connection, etc. FIG. 8BB shows a Web page 456 from the Assembly section with information related to the instructions how to use the control device Web interface.

A synopsis of the actions to be taken using the keyboard of the control device is shown diagrammatically in FIGS. 4A-4C.

By using the network, the lock management program allows a user to manage a large number of locks simultaneously (approximately 90,000) which will allow any user to have permanent online control of all the locks he or she has installed.

The microprocessor firmware, including the control device control program, is written in ANSI C and Assembler. The lock management program is written in C++.

Modifications and variations of the above-described embodiments of the present invention are possible, as appreciated by those skilled in the art in light of the above teachings. It is therefore to be understood that, within the scope of the appended claims and their equivalents, the invention may be practiced otherwise than as specifically described. Modifications and variations of the above-described embodiments of the present invention are possible, as appreciated by those skilled in the art in light of the above teachings. It is therefore to be understood that, within the scope of the appended claims and their equivalents, the invention may be practiced otherwise than as specifically described.

I claim:

1. An Internet Protocol lock management system for use with at least one electronic/electromechanical lock, comprising:
at least one electronic control means for managing an associated electronic/electromechanical lock from a standard TCP/IP network, the at least one electronic control means having its own IP address.

2. The system of claim 1, wherein the electronic control means comprises:
means for serving up configuration and inquiry Web pages from a standard web browser;
means for controlling and supervising temporary processes that govern the lock; and
means for handling interactions with a local electronic input device.

3. The system of claim 2, where in the means for controlling and supervising temporary processes that govern the lock includes:
means for controlling who can use and operate the lock means for controlling when the lock is enabled and disabled;
means for controlling the length of time between entry of a lock combination and reaching a window when the lock is openable; and
means for recording an audit trail of who has opened the lock and what times the lock is opened and closed.

4. The system of claim 2, further comprising means for responding to remote orders from a remote lock management program resident in a control post on the network.

5. The system of claim 1, further comprising computer-resident lock management means for managing locks through the at least one control device.

6. The system of claim 5, wherein the lock management means includes:
means for adding a lock to a network supporting the TCP/IP protocol and configuring the lock;
means for deleting a lock from a network supporting the TCP/IP protocol;
means for editing the configuration of a lock in the network supporting the TCP/IP protocol;
means for programming resources of a lock in the network supporting the TCP/IP protocol; and
means for verifying the status of a lock in the network supporting the TCP/IP protocol.

7. The system of claim 6, wherein the lock management means further includes:
means for adding a plurality of locks having the same configuration to a network supporting the TCP/IP protocol;
means for editing the configuration of a plurality of locks in the network supporting the TCP/IP protocol at the same time;
means for programming resources of a plurality of locks in the network supporting the TCP/IP protocol at the same time; and
means for verifying the status of a plurality of locks in the network supporting the TCP/IP protocol at the same time.

8. The system of claim 1, comprising a plurality of the electronic control means, each electronic control means being associated with a lock and including means for serving up configuration and inquiry Web pages from a standard web browser, wherein the system has a non-hierarchical configuration and each electronic control means communicates directly with a network supporting the TCP/IP protocol.

9. The system of claim 1, comprising a master control means and at least one slave control means, the master electronic control means and each slave electronic control means being associated with a lock, only the master control means including means for serving up configuration and inquiry Web pages from a standard web browser, wherein the system has a master/slave configuration and the master electronic control device and all of the slave electronic control devices communicate with a network supporting the TCP/IP protocol, the master and slave control means being controlled through the Web pages served by the master electronic control means.

10. An electronic control device for managing a lock from a network supporting the TCP/IP protocol, the electronic control device having its own IP address and comprising:
means for serving up configuration and inquiry Web pages from a standard web browser;
means for controlling and supervising temporary processes that govern the lock; and
means for handling interactions with a local electronic input device.

11. The electronic control device of claim 8, where in the means for controlling and supervising temporary processes that govern the lock includes:
means for controlling who can use and operate the lock means for controlling when the lock is enabled and disabled;
means for controlling the length of time between entry of a lock combination and reaching a window when the lock is openable; and
means for recording an audit trail of who has opened the lock and what times the lock is opened and closed.

12. The electronic control device of claim 8, further comprising means for responding to remote orders from a remote lock management program resident in a control post on the network.
